(19) United States
(12) Patent Application Publication
(10) Pub. No.: US 2025/0093216 A1
(43) Pub. Date: Mar. 20, 2025

(54) SENSORS FOR SEMICONDUCTOR PROCESSING TOOLS

(71) Applicant: Lam Research Corporation, Fremont, CA (US)

(72) Inventors: Ravikumar PATIL, Bangalore (IN); Keerthi GOWDARU, Bangalore (IN); Pawan Murlidhar PATIL, Mumbai (IN); Karl Frederick LEESER, West Linn, OR (US)

(73) Assignee: Lam Research Corporation, Fremont, CA (US)

(21) Appl. No.: 18/728,348

(22) PCT Filed: Feb. 20, 2023
(86) PCT No.: PCT/US2023/062893

§ 371 Date: Jul. 11, 2024

Related U.S. Application Data
(60) Provisional application No. 63/268,336, filed on Feb. 22, 2022.

(51) Int. Cl. G01K 11/32; G01K 1/08; G01K 1/14; G01K 11/22

(52) U.S. Cl. CPC G01K 11/32; G01K 1/08; G01K 1/14; G01K 11/22

(57) ABSTRACT

Described herein is a pedestal assembly comprising a platen and a sensor support plate below the platen. In at least one implementation, sensor support plate comprises a sensor compartment and a waveguide temperature sensor within the sensor compartment. In at least one implementation, waveguide temperature sensor comprises a temperature sensor comprising a first reflector structure and a second reflector structure. In at least one implementation, first reflector structure and second reflector structure are separated by a gauge length.

### CLAIM FOR PRIORITY

This application claims priority to U.S. Provisional Patent Application No. 63/268,336, filed on Feb. 22, 2022, titled “ULTRASONIC DISTRIBUTED TEMPERATURE SENSORS FOR SEMICONDUCTOR PROCESSING TOOLS”, and which is incorporated by reference in entirety.

### BACKGROUND

Processing tools are used to perform treatments such as deposition and etching of film on substrates like semiconductor wafers. For example, deposition may be performed to deposit a conductive film, a dielectric film, or other types of film using chemical vapor deposition (CVD), plasma enhanced CVD (PECVD), atomic layer deposition (ALD), plasma enhanced ALD (PEALD), and/or other deposition processes. Deposition may be performed in a wafer processing chamber such as a PECVD chamber comprising multiple stations for processing more than one wafer at a time.

Temperature sensing of critical components such as wafer pedestal assemblies and showerheads both accurately and precisely is important for process control. Currently, wafer pedestal assembly or showerhead heater input control at any given set point is achieved by a single thermocouple (TC) or resistance temperature detector (RTD). These TCs are usually spring loaded and are dependent on junction integrity (prone to junction failure). Deformation of components during heating changes this contact pressure resulting in variation of temperature. In order to measure spatial variation of temperature, multiple TCs need to be incorporated into system that is cumbersome and at times difficult to accommodate.

To measure spatial temperature variation within a wafer pedestal assembly, wafer TCs that comprise multiple TCs integrated into a wafer substrate may be employed. Wafer TCs may be placed on top of wafer pedestal assembly. Though method gives accurate temperature variations on surface of a wafer pedestal assembly, it cannot be used in-situ during processing conditions (especially in presence of plasma). Currently, there are no practical solutions to multipoint temperature measurement on other regions of substrate processing tools, such as within a showerhead or chamber wall. With multizone heater wafer pedestal assemblies in development, it is important to understand temperature distribution in dynamic process conditions and hence need for multipoint temperature sensing of better process control. To be most effective, zone temperatures in multizone wafer pedestal assemblies (and other process components) may need to be independently monitored. While discrete TCs or RTDs may be placed at strategic locations within a wafer pedestal assembly or other process tool component, these solutions may not be robust to some microelectronic device fabrication processes. As noted above, TCs or RTDs may be generally incompatible with plasma-enhanced depositions or etches processes due to electromagnetic environment dominating process chamber. In another example, particle defects in a deposited layer may occur due to thermal gradients across face plate of showerhead, wafer pedestal assembly or chamber surface walls. A multipoint temperature sensing approach helps to identify cold/hot spots for potential troubleshooting. Currently, multipoint temperature sensing inside wafer pedestal assemblies and showerheads have not been currently implemented in semiconductor process-critical components such as wafer pedestal assemblies, showerheads, shields and chamber. Hence there is a need for multipoint temperature sensing that may be employed in-situ during many types of semiconductor (and other materials) device fabrication processes in a variety of portions of a substrate processing tool.

### BRIEF DESCRIPTION OF THE DRAWINGS

Material described herein is illustrated by way of example and not by way of limitation in accompanying figures. For simplicity and clarity of illustration, elements illustrated in figures are not necessarily drawn to scale. For example, dimensions of some elements may be exaggerated relative to other elements for clarity. Also, various physical features may be represented in their simplified “ideal” forms and geometries for clarity of discussion, but it is nevertheless to be understood that practical implementations may only approximate illustrated ideals. For example, smooth surfaces and square intersections may be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1A illustrates an exploded isometric view of a pedestal assembly, in accordance with at least one implementation.

FIG. 1B illustrates an assembled isometric view of pedestal assembly of FIG. 1A, in accordance with at least one implementation.

FIG. 1C illustrates a plan view of pedestal assembly of FIG. 1A, in accordance with at least one implementation.

FIG. 2A illustrates a cross sectional view of a temperature sensor strip assembly anchored to a sensor support plate and platen, in accordance with at least one implementation.

FIG. 2B illustrates a cross-sectional view of temperature sensor strip assembly of FIG. 2A, in accordance with at least one implementation.

FIG. 3 illustrates a plan view of temperature sensor strip assembly of FIG. 2A, in accordance with at least one implementation.

FIG. 4 illustrates an isometric 3-D view of a pedestal assembly comprising a serpentine temperature sensor strip, in accordance with at least one implementation.

FIG. 5A illustrates an isometric 3-D view of a pedestal assembly, comprising a helical spiral temperature sensor strip, in accordance with at least one implementation.

FIG. 5B illustrates an orthogonal cross-sectional view of pedestal assembly of FIG. 5A, in accordance with at least one implementation.

FIG. 5C illustrates an isometric 3-D view of a pedestal assembly comprising a dual helical spiral temperature sensor strip, in accordance with at least one implementation.

FIG. 5D illustrates an orthogonal cross-sectional view of pedestal assembly of FIG. 5C, in accordance to at least one implementation.

FIG. 6 illustrates a plan view of a pedestal assembly comprising a folded temperature sensor strip, in accordance to at least one implementation.

FIG. 7 illustrates a plan view of a pedestal assembly comprising a segmental temperature sensor strip, in accordance with at least one implementation.

FIG. 8 illustrates a plan view of a pedestal assembly comprising circular temperature sensor strip, in accordance to at least one implementation.

FIG. 9A illustrates a partial profile view of a temperature sensor strip of FIG. 1A,

in accordance with at least one implementation.

FIG. 9B illustrates an echogram of temperature sensor strip of FIG. 9A, in accordance with at least one implementation.

FIG. 10 illustrates an exemplary calibration curve, in accordance with at least one implementation.

FIGS. 11A and 11B illustrate 3D views of symmetric grooves and a single non-symmetric groove, respectively, in accordance with at least one implementation.

FIGS. 11C and 11D illustrate a three-dimensional view of cylindrical acoustic waveguide temperature sensor, in accordance with at least one implementation.

FIG. 12 illustrates a plan view of a showerhead comprising a waveguide temperature sensor, in accordance with at least one implementation.

FIG. 13 illustrates an implementation of a waveguide temperature sensor within a process tool, in accordance with at least one implementation.

FIG. 14 illustrates a process flow chart summarizing an exemplary method of operation of an ultrasonic waveguide temperature sensor coupled to a process tool, in accordance with at least one implementation.

FIG. 15 illustrates a system comprising a process tool, in accordance with at least one implementation.

### DETAILED DESCRIPTION

Here, numerous specific details are set forth, such as structural schemes, to provide a thorough understanding of one or more implementations. It may be apparent to one skilled in the art that implementations may be practiced without these specific details. In other instances, well-known features, such as gas line tubing fittings, heating elements and snap switches, are described in lesser detail to not unnecessarily obscure implementations of the present disclosure. Furthermore, it is to be understood that implementations shown in figures are illustrative representations and may not be drawn to scale.

In some instances, well-known methods and devices are shown in block diagram form, rather than in detail, to avoid obscuring present disclosure. Reference throughout this specification to “an implementation” or “one implementation” or “at least one implementation” or “some implementations” means that a particular feature, structure, function, or characteristic described in connection with an implementation is included in at least one implementation. Thus, appearances of phrase “in an implementation” or “in at least one implementation” or “in one implementation” or “some implementations” in various places throughout this specification are not necessarily referring to a same implementation. Furthermore, features, structures, functions, or characteristics may be combined in any suitable manner in one or more implementations. For example, a first implementation may be combined with a second implementation anywhere features, structures, functions, or characteristics associated with two implementations are not mutually exclusive.

Here, “coupled” and “connected,” along with their derivatives, may be used herein to describe functional or structural relationships between components. These terms are not intended as synonyms for each other. Rather, in particular implementations, “connected” may be used to indicate that two or more elements are in direct physical, optical, or electrical contact with each other. “Coupled” may be used to indicated that two or more elements are in either direct or indirect (with other intervening elements between them) physical, electrical or in magnetic contact with each other, and/or that two or more elements co-operate or interact with each other (e.g., as in a cause an effect relationship).

Here, “over,” “under,” “between,” and “on” as used herein refer to a relative position of one component or material with respect to other components or materials where such physical relationships are noteworthy. Unless these terms are modified with “direct” or “directly,” one or more intervening components or materials may be present. Similar distinctions are to be made in context of component assemblies. As used throughout this description, and in claims, a list of items joined by term “at least one of” or “one or more of” can mean any combination of listed terms.

Here, “adjacent” may generally refers to a position of a thing being next to (e.g., immediately next to or close to with one or more things between them) or adjoining another thing (e.g., abutting it).

Here, “pedestal assembly” may generally refer to one or more parts of a pedestal employed in a process tool.

Here, “pedestal” may generally refer to a platform for supporting a wafer substrate. In at least one implementation, pedestal may comprise a pedestal assembly according to at least one implementation.

Here “platen” may generally refer to a flat portion of a pedestal assembly that is operable to support a wafer substrate for processing within a process tool

Here, “sensor support plate” may generally refer to a component of a pedestal assembly that is below a platen. In at least one implementation, sensor support plate may provide a housing for a waveguide temperature sensor.

Here, “sensor compartment” may generally refer to a component of pedestal assembly that is a cavity within a sensor support plate.

Here, “waveguide temperature sensor” may generally refer to an acoustic or optical waveguide strip, wire or optical fiber comprising reflector structures distributed along a length of a waveguide. In at least one implementation, segments of waveguide between adjacent reflector structures are temperature sensors.

Here, “temperature sensor strip” may generally refer to an acoustic waveguide temperature sensor having a rectangular cross section.

Here, “reflector structure” may generally refer to one or more discontinuities along an acoustic or optical waveguide. In at least one implementation, reflector structures may be grooves or notches. In at least one implementation, discontinuities may cause reflections of ultrasonic or optical signals launched into a waveguide.

Here, “gauge length” may generally refer to a distance between adjacent discontinuities. In at least one implementation, gauge length may be associated with temperature sensors distributed along a waveguide temperatures sensor.

Here, “temperature sensor” may generally refer to a segment of a waveguide temperatures sensor that extends between adjacent reflector structures. In at least one implementation, a temperature structure comprises a segment of a waveguide temperature sensor and includes adjacent reflector structures at opposing ends of a segment of a waveguide.

Here, “strip” may generally refer to a waveguide temperature sensor having a rectangular cross section.

Here, “acoustic signal” may generally refer to an ultrasonic excitation launched into an acoustic waveguide temperature sensor from a transducer.

Here, “transducer” may generally refer to a converter that converts energy from one from to another form. In at least one implementation, a transducer may be a piezoelectric transducer capable of producing mechanically excited shear waves (e.g., due to vibration normal to a contact surface) of frequencies up to several megahertz. In at least one implementation, excitation of ultrasonic shear waves may be coupled to a waveguide temperature sensor by mechanical contact with a transducer.

Here, “ultrasonic transducer” may generally refer to a device that is operable to couple ultrasonic signals into a waveguide and receive reflected ultrasonic signals returning from waveguide.

Here “spiral geometry” may generally refer to a spiral form of waveguide temperature sensor.

Here, “straight segments” may generally refer to a temperature sensor strip having one or more interconnected segments that are straight. In at least one implementation, straight segments may extend at different angles from one another.

Here, “fold” may generally refer to transitions between straight segments, where a temperature sensor strip may be folded to form straight segments.

Here, “unit” may generally refer to a temperature sensor strip that is divided into separate smaller temperature sensor strips.

Here, “surface” may generally refer to a surface of a component of a pedestal assembly. In at least one implementation, a surface may be a floor surface of a sensor compartment of a sensor support plate.

Here, “groove” may generally refer to a track within a surface in which a temperature sensor strip may be seated.

Here, “upper edge” may generally refer to a high edge of a temperature sensor strip that is oriented vertically.

Here, “lower edge” may generally refer to a low edge of a temperature sensor strip that is oriented vertically.

Here, “frame segment” may generally refer to a rigid guide that is attached to edges of a vertically oriented temperature sensor strip. In at least one implementation, a frame segment may enable a temperature sensor strip to be anchored to a surface.

Here, “upper frame segment” may generally refer to a frame segment that is attached to an upper edge of a temperature sensor strip.

Here, “lower frame segment” may generally refer to a frame segment that is attached to a lower edge of a temperature sensor strip.

Here, “helical spiral” may generally refer to a helix that has a diminishing diameter along its axis.

Here, “sidewall” may generally refer to a wide wall of a temperature sensor strip.

Here, “wavelength” may generally refer to a distance between crests or troughs of a wave.

Here, “shear modulus” may generally refer to a physical property of a material. In at least one implementation, shear modulus may be related to transverse strain on a solid bar of material.

Here, “optical fiber” may generally refer to an optical waveguide in form of a thin fiber.

Here, “Bragg grating reflector structures” may generally refer to reflector structures on an optical fiber.

Here, “thermographic phosphors” may generally refer to molecules that change refractive index properties with changes in temperature.

Here, “vacuum chamber” may generally refer to a chamber operable to hold a high vacuum. In at least one implementation, vacuum chamber may be a component of a process tool. In at least one implementation, vacuum chamber may enable fabrication of semiconductor devices by vacuum processes.

Here, “terminal lead” may generally refer to a portion of a waveguide temperature sensor that is coupled to an acoustic transducer, such as an ultrasonic transducer.

Here, “showerhead” may generally refer to a process gas distribution manifold that is employed in a vacuum chamber.

Here, “faceplate” may generally refer to a perforated flat plate of a showerhead. In at least one implementation, process gases may flow through apertures in faceplate of a showerhead.

Here, “return signal” may generally refer to a reflected pulse or echo of an ultrasonic or optical pulse launched into a waveguide temperature sensor.

Here, “time-of-flight” (TOF) may generally refer to measurement of time required for a pulse signal to propagate a distance. In at least one implementation, a TOF may be measured for an ultrasonic pulse to propagate to a reflector structure and return to its source.

Here, “difference” may generally refer to a difference between TOF measurements emanating from two or more reflector structures.

Unless otherwise specified in explicit context of their use, here, “substantially equal,” “about equal” and “approximately equal” mean that there is no more than incidental variation between two things so described. In at least one implementation, such variation is typically no more than +/−10% of referred value.

To address various limitations described herein, waveguide temperature sensors for multipoint temperature sensing are disclosed. In at least one implementation, a waveguide temperature sensor may be a waveguide having different propagation properties with changing temperature. In at least one implementation, a waveguide temperature sensor may include a plurality of reflecting structures that reflect a propagating wave. In at least one implementation, time-of-flight (TOF) of reflected waves are measured to determine a relationship between temperature of waveguide and velocity (or other properties) of reflected waves. In at least one implementation, waveguide temperature sensors may comprise an acoustic or an optical waveguide having a length to width or diameter ratio that is greater than, for example, 5:1. In at least one implementation, a waveguide temperature sensor may comprise a strip waveguide comprising one or more waveguide segments that extend between reflector structures. In at least one implementation, in contrast to discrete temperature sensors, waveguide temperature sensors are not affected by harsh conditions of RF plasmas or chemistries within a process tool vacuum chamber.

In at least one implementation, reflector structures may generally be structural and/or material discontinuities. In at least one implementation, a reflector structure may be a groove or notch machined into sidewall of a waveguide. In at least one implementation, groove or notch may provide an abrupt change in waveguide cross section at one or more points along length of waveguide. In at least one implementation, waveguide segment extending between a pair of adjacent reflector structures may be defined as a distributed temperature sensor. In at least one implementation, a temperature sensor may include pair of adjacent reflector structures at termini of waveguide segment. In at least one implementation, a temperature sensor may also be characterized by its gauge length, defined as length of waveguide segment up to and including pair of adjacent reflector structures.

In at least one implementation, multiple points may each reflect a portion of incident wave energy injected into waveguide by a transducer, acoustic or optical, propagating down waveguide. In at least one implementation, reflected wave energy may propagate back toward source of energy, generally coupled back into transducer. For example, in at least one implementation, an optical or an ultrasonic transducer may be attached to one terminus of a waveguide as a source of wave energy, both transmitting and receiving energy. In at least one implementation, reflected wave energy may travel back to source end of waveguide, while incident energy continues to travel to opposite terminus of waveguide. In at least one implementation, incident waves may eventually be reflected at terminus of waveguide.

In at least one implementation, a waveguide temperature sensor may be incorporated on or within some process tool components. In at least one implementation, one or more waveguide temperature sensors, may be incorporated within interior of a pedestal assembly employed in a process tool for device fabrication from semiconductors and other materials. In at least one implementation, one or more waveguide temperature sensors may be incorporated within a process gas distribution showerhead that is also part of a process tool employed for CVD and PECVD processes or plasma etch processes (e.g., a dry reactive ion etching [DRIE] process). In at least one implementation, one or more waveguide temperature sensors may be incorporated along interior surfaces within a process tool (e.g., deposition or etch) vacuum chamber. In at least one implementation, waveguide temperature sensors may be employed on exterior surfaces of a semiconductor process chamber, or other componentry external to chamber. In at least one implementation, a waveguide temperature sensor may be attached to heated gas lines, vessels, and other components.

In at least one implementation, waveguide temperature sensors may be distributed along length of a waveguide. In at least one implementation, discontinuities may be manufactured along waveguide to cause transmitted acoustic or optical energy to be reflected back toward transducer, which is also signal source. In at least one implementation, time of flight (TOF) of reflected acoustic waves may be measured and correlated to local temperature of individual temperature sensors distributed along waveguide. In at least one implementation, TOF may be defined as travel time for a signal that is injected into waveguide (e.g., referred to as an incident signal, or a forward signal) to reach a reflector structure and be reflected toward source. In at least one implementation, time of round trip of forward and reflected signals may be termed “time of flight”, TOF. In at least one implementation, in case of acoustic signals, TOF may be generally governed by velocity of sound within material of waveguide. In at least one implementation, optical signals may travel at substantially velocity of light within material of an optical waveguide, generally an optical fiber. In at least one implementation, properties of materials that govern speed of sound or light, such as Young's modulus or refractive index, may vary with temperature.

In at least one implementation, for optical waveguide temperature sensors, spectral shifts of reflected white light components travelling in fiber optic waveguides may be measured and correlated to local temperature of individual waveguide temperature sensors employing fiber Bragg gratings (FBGs). In at least one implementation, FBGs may exhibit temperature-dependent changes in local refractive index of gratings as well as temperature-induced changes in grating distance. In at least one implementation, other suitable temperature-sensitive optical detection methods may also be employed, such as thermally sensitive luminescence decay lifetimes of thermographic phosphors may be employed as coatings on optical fibers.

In at least one implementation, temperature-induced changes of signal velocity (e.g., velocity of sound or light) may cause shifts in TOF of reflected signals returning to source (e.g., return signals) in both optical and acoustic waveguides. In at least one implementation, TOF shifts may be correlated to temperature of waveguide segment between adjacent pairs of reflector structures. In at least one implementation, a calibration curve may be obtained by such correlations, affording automated multipoint temperature measurements by a single waveguide temperature sensor comprising multiple temperature sensors along length of waveguide. In at least one implementation, by shaping waveguide temperature sensor, individual temperature sensors may be collocated at selected positions on a surface of a process tool. In at least one implementation, individual temperature sensors may be collocated at predetermined measurement points to measure a local temperature in vicinity of individual temperature sensor.

In at least one implementation, a local temperature may be a temperature of surface upon which temperature sensor is in contact. In at least one implementation, a waveguide temperature sensor may detect variations in local temperatures within a component of a process tool, such as a pedestal, employed in semiconductor device manufacture. In at least one implementation, multipoint temperature detection may provide detection of local hot or cold spots, as well as temperature gradients. In at least one implementation, process tool components may non-exhaustively include chucks, showerheads, and vacuum chamber surfaces.

In at least one implementation, spatial resolution of temperature measurements obtained by a waveguide temperature sensor may be related to gauge length of individual temperature sensors distributed along its length. In at least one implementation, gauge length may be defined for purposes of this disclosure to be spacing between discontinuity pairs. In at least one implementation, time of flight of reflected signals may be measured and correlated to local temperatures in vicinity of corresponding discontinuities.

In at least one implementation, implementation of waveguide temperature sensors may provide an advantage over deployment of discrete temperature sensors such as thermocouples and resistance temperature detector (RTD) sensors within a process tool. Incorporation of discrete temperature sensors may significantly increase material and labor cost in tool manufacture. Additionally, discrete temperature sensors may be difficult to deploy in numbers large enough for high-resolution spatial temperature mapping. In at least one implementation, a single WDT sensor may advantageously provide multipoint temperature measurements within a process tool at low material and manufacture cost. In at least one implementation, a single ultrasonic transducer or light coupling may be employed to inject wave pulses and detect reflected waves from a multipoint waveguide temperature sensor, further reducing cost. In at least one implementation, waveguide temperature sensors may generally not interact with radio frequency (RF) fields that are commonly employed to initiate and sustain plasmas in PECVD and plasma etch process tools.

In at least one implementation, wave propagation modes may be determined by orientation of a transducer with respect to waveguide axis. In at least one implementation, a transducer may generate transverse or longitudinal waves if transducer excitation is parallel to or orthogonal to longitudinal (or transverse) axis of waveguide. In at least one implementation, acoustic waveguide temperature devices may have a rectangular strip geometry. In at least one implementation, acoustic wave propagation modes specific to rectangular geometries may be selected for least amount of dispersion and loss due to leakage of acoustic energy from waveguide to surrounding structures or atmosphere coupled to waveguide. In at least one implementation, in a strip waveguide, a fundamental shear horizontal mode (SH₀) may be selected for lowest loss and dispersion in comparison to other modes within strip waveguides. In at least one implementation, rectangular cross section of a strip waveguide may have dimensions of at least 5:1 to enable substantially exclusive propagation of SH₀ mode. In at least one implementation, some dimensions are related to wavelength of acoustic waves.

In at least one implementation, acoustic waveguide devices may have a cylindrical geometry. In at least one implementation, cylindrical geometry may comprise a circular or suitable non-circular cross section, such as an oval, ellipsoid, square, hexagonal, or octagonal cross section, for example. In cylindrical waveguides, fundamental transverse mode (e.g., T₀) may exhibit most desirable acoustic propagation characteristics. In at least one implementation, cross sections of cylindrical waveguides may be engineered to sustain propagation of T₀ mode. In at least one implementation, transducer may be coupled to cylindrical waveguide accordingly.

In at least one implementation, a waveguide temperature sensor may be folded into different shapes to fit within a confined space of a process tool component without substantially affecting performance. In at least one implementation, two or more waveguide temperature sensors may be nested in different configurations and have varying geometric shapes.

In at least one implementation, waveguide dimensions may be restricted due to spatial constraints within processing tool. In at least one implementation, waveguide temperature sensors may also be routed over surfaces of shields or chamber walls of a substrate processing tool. In some implementations, routing of waveguide temperature sensor may entail dimensional constraints. To address these constraints, in at one implementation, wavelength of ultrasonic waves may be 3 mm or less. In at least one implementation, to optimize sensor to accommodate dimensional constraints, frequencies of 1 megahertz (MHz) or higher may be employed. In at least one implementation, in aluminum, ultrasonic waves of 1 MHz have a wavelength of approximately 3 mm.

In at least one implementation, acoustic waveguides may comprise a metallic, plastic, or ceramic material. In at least one implementation, shape of waveguides may be solid rectangular strips, cylinders, or tubes. In at least one implementation, discontinuities may comprise periodic or non-periodic grooves or pre induced geometric variations such as bends. In at least one implementation, mounting of waveguide temperature sensors may have minimal contact of waveguide with surrounding structures. In at least one implementation, a temperature sensor strip may comprise rails along segments of waveguide edges for minimizing attenuation of ultrasonic energy by leakage to surrounding structures.

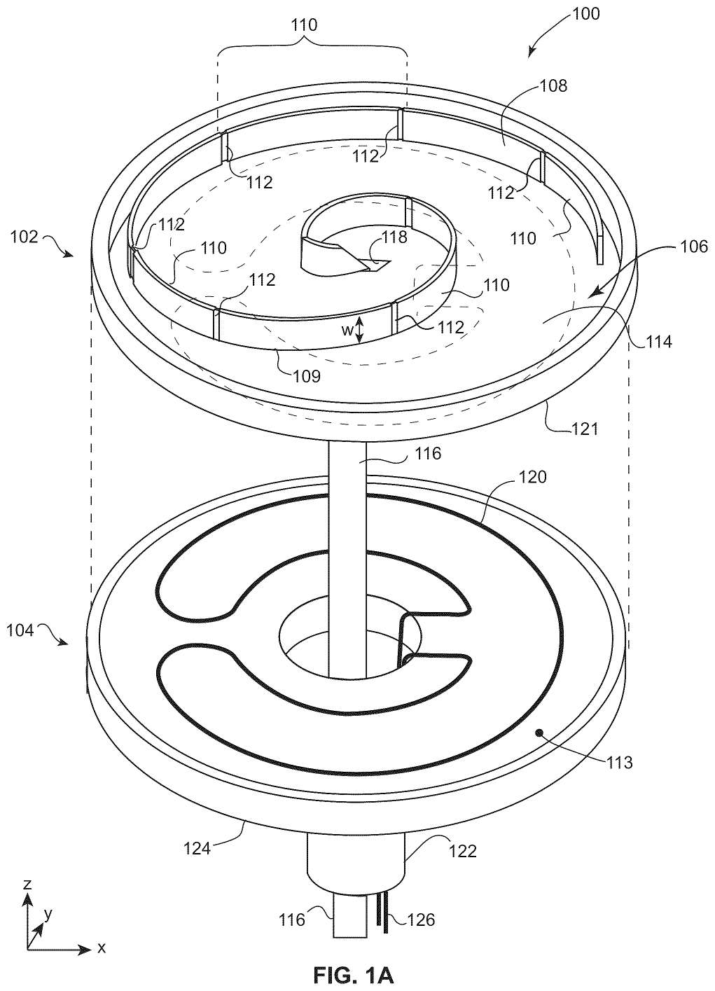

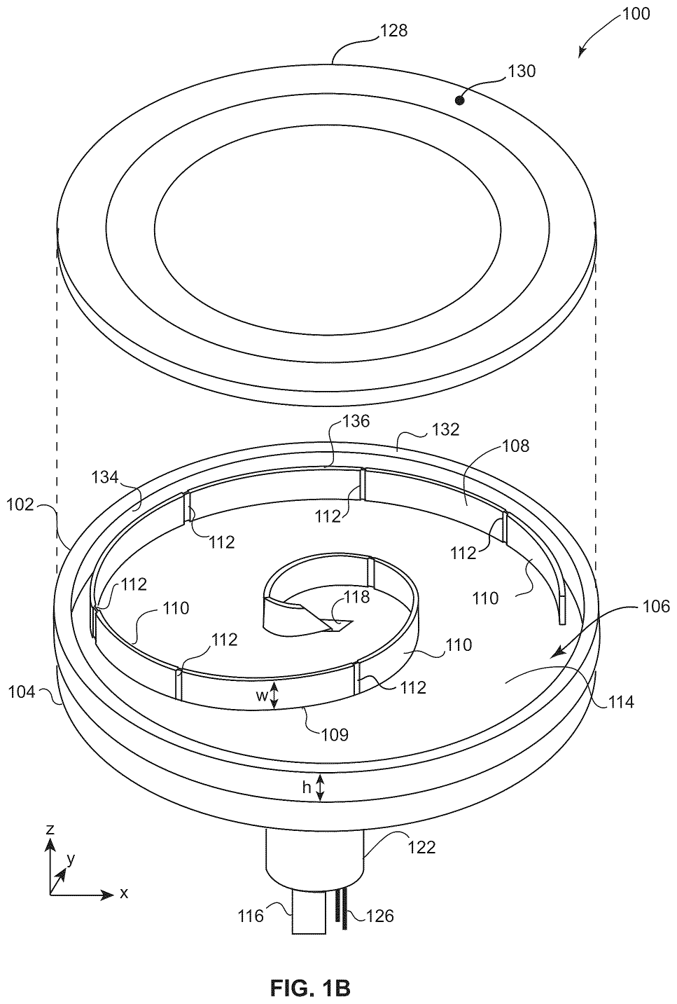

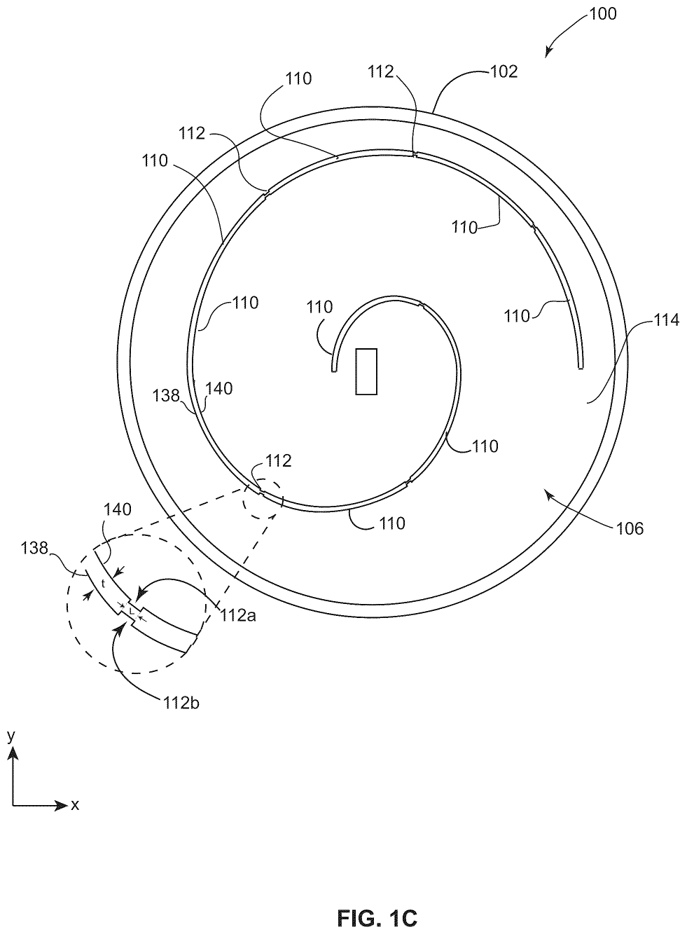

FIG. 1A illustrates an exploded isometric view of a pedestal assembly 100, in accordance with at least one implementation. In at least one implementation, pedestal assembly 100 may be employed in a wafer processing station of a semiconductor processing tool. In at least one implementation, a semiconductor processing tool may be a deposition tool or an etching tool comprising a vacuum chamber. In at least one implementation, both deposition and etch may employ a radio frequency environment, for example, to initiate and maintain a plasma for plasma-enhanced chemical vapor deposition (PECVD) processes or plasma etch processes. In at least one implementation, other deposition processes are within scope of description. In at least one implementation, pedestal assembly 100 may be a multi-component structure comprising sensor support plate 102 and heater support plate 104. In at least one implementation, heater support plate is stacked below sensor support plate 102. In at least one implementation, sensor support plate 102 and heater support plate 104 are fastened together with bolts or screws (not shown). In at least one implementation, sensor support plate 102 comprises sensor compartment 106. In at least one implementation, temperature sensor strip 108 is housed within sensor compartment 106. In at least one implementation, width w of temperature sensor strip 108 is vertically oriented (e.g., aligned with z-direction) within sensor compartment 106, where temperature sensor strip 108 may be edge-contacted to floor 114 of sensor compartment. In at least one implementation, lower edge 109 of temperature sensor strip 108 may be in thermal contact with floor 114 of sensor compartment 106. In at least one implementation, to accommodate spatial constraints, dimensions of sensor compartment 106, temperature sensor strip 108 may be folded into a spiral form to fit within sensor compartment 106, as shown.

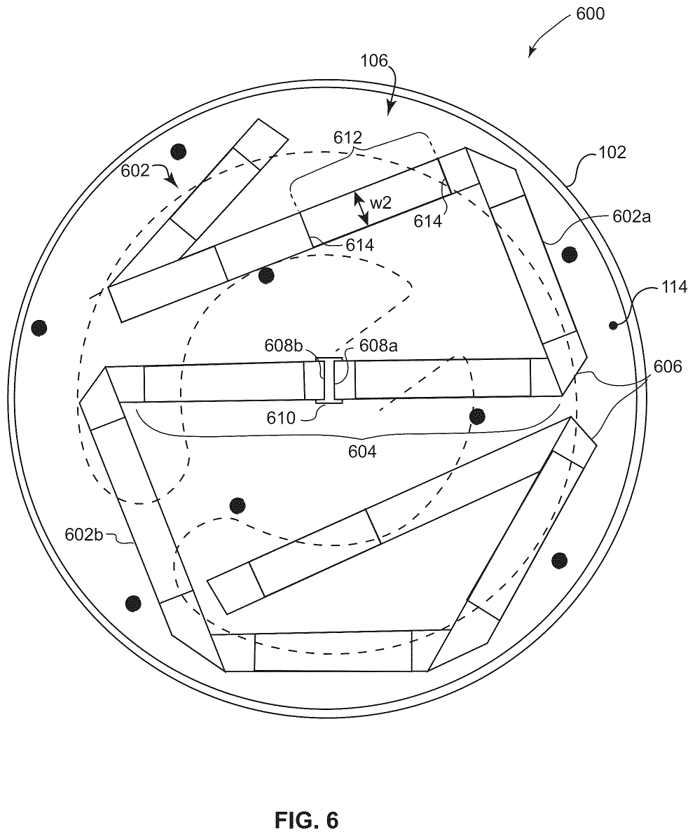

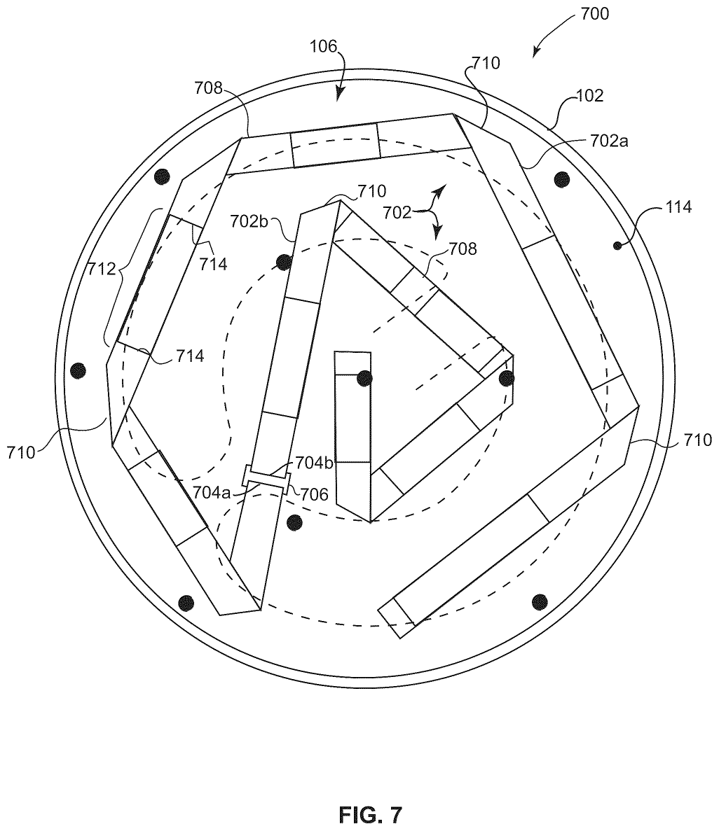

In at least one implementation, temperature sensor strip 108 comprises a solid strip waveguide structure, as shown, having a high aspect ratio rectangular cross section (e.g., see FIG. 6). In at least one implementation, a high aspect ratio is a ratio which is at least 10:1. In at least one implementation, temperature sensor strip 108 may also comprise a solid cylindrical wire waveguide for conducting ultrasonic waves. In at least one implementation, temperature sensor strip 108 may comprise a tubular waveguide, for example, comprising a core of air or other fluid. In at least one implementation, core may comprise a solid material. In at least one implementation, an optical waveguide comprising an optical fiber may be employed in lieu of temperature sensor strip 108. In at least one implementation, a structural component similar to temperature sensor strip 108 may be employed inside or exterior to process tool. In at least one implementation, a heated gas line may be modified to include discontinuities, such as grooves, which can cause wave reflections.

Referring to FIG. 1A, in at least one implementation, temperature sensor strip 108 comprises multiple temperature sensors (TS) 110 distributed along temperature sensor strip 108. In at least one implementation, temperature sensor strip 108 is an acoustic waveguide, whereby acoustic (ultrasonic) excitation travels longitudinally along temperature sensor strip 108. In at least one implementation, temperature sensor strip 108 comprises materials having a high acoustic transmissivity (low acoustic attenuation), that may support a substantially non-dispersive sound propagation mode (e.g., shear-horizontal mode SH₀) in a strip waveguide or a transverse (e.g., T_{0,1}) mode in a cylindrical waveguide. In at least one implementation, suitable materials include, but are not limited to, aluminum, stainless steel, tungsten, titanium, silica, borosilicate glasses, aluminum oxide, titanium oxides, aluminum nitride, and some organic polymers.

In at least one implementation, temperature sensors 110 extend between pairs of adjacent grooves 112. In at least one implementation, compositional material may be chosen to fulfill inter-related design criteria. In at least one implementation, temperature sensor strip 108 may be required to accommodate dimensional constraints of an apparatus in which temperature sensor strip 108 may be incorporated. In at least one implementation, temperature sensor strip 108 may be required to have a width that may fit within height constraints (e.g., height h) of sensor compartment 106. In at least one implementation, to meet this design criterion, a material may be chosen at least partially on basis of phase velocity of sound within material.

In at least one implementation, an operational criterion of temperature sensor strip 108 may be single mode excitation and propagation of lowest order of shear horizontal mode (SH₀). In at least one implementation, SH₀ mode comprises vibrational displacements (e.g., amplitude maxima and minima) transverse to thickness (e.g., vibrations along width dimension transverse to thickness dimension, parallel to plane of strip waveguide) of strip waveguide. In at least one implementation, lowest order of shear horizontal mode (SH₀) may be chosen due to its dispersion characteristics in certain materials. In at least one implementation, SH₀ mode in strip waveguides becomes substantially non-dispersive (e.g., phase velocity is substantially constant with frequency) above a threshold excitation frequency. In at least one implementation, threshold frequency may be approximately 1 MHZ for a material having a bulk shear velocity of approximately 3000 m/s (e.g., aluminum, stainless steel). In at least one implementation, in materials such as aluminum or steel (or other materials having approximately same bulk shear velocity), shear velocity of SH₀ excitation mode is substantially constant at frequencies above approximately 1 MHZ.

In at least one implementation, as sound velocity of SH₀ mode exhibits negligible dispersion and loss in many materials above threshold frequency (e.g., shear velocity is substantially constant above 1 MHZ), it may be chosen to meet this operational criterion for strip waveguides. In at least one implementation, any convenient frequency above 1 MHZ may be chosen as frequency of operation. In at least one implementation, other modes, such as A0 mode of Lamb wave mode (vibration displacements transverse to width surface) may also be considered. In at least one implementation, A0 mode may be less dispersive than other modes but still more dispersive than SH₀ mode, slower to approach bulk shear velocity of material than SH₀ mode. In at least one implementation, temperature sensors 110, which may be waveguide segments, may have uniform or non-uniform gauge lengths, where a gauge length is distance between pairs of adjacent grooves 112.

In at least one implementation, grooves 112 may extend transversely to a long axis of temperature sensor strip 108. In at least one implementation, grooves 112 constitute structural discontinuities that may act as reflector structures. In at least one implementation, grooves 112 may be regarded as an abrupt structural or material change, entailing a discontinuity, along length of temperature sensor strip 108. In at least one implementation, such structures can cause reflections of ultrasonic waves that are excited within temperature sensor strip 108, as described below. In at least one implementation, temperatures are measured as time-of-flight (TOF) of acoustic reflections from grooves 112.

In at least one implementation, multiple reflections may be recorded from a single pulse of ultrasound. In at least one implementation, reflected ultrasound pulses may be correlated by TOF measurements to individual grooves 112. In at least one implementation, other types of reflector structures that can cause acoustic reflections may be substituted for grooves 112. In at least one implementation, such reflector structures are discontinuities, and may non-exhaustively include grooves, notches, abrupt changes in dimensions and/or materials including bulges, bends, protrusions, blocks of dissimilar material, which are machined, etched into, or assembled onto sidewalls of temperature sensor strip 108. In at least one implementation, reflector structures may be regularly or irregularly spaced along temperature sensor strip 108.

In at least one implementation, because of non-dispersive nature of SH₀ (or A₀) mode, time of flight may be substantially independent of frequency above threshold frequency (e.g., greater than 1 MHZ). In at least one implementation, free selection of suitable operating frequencies may be enabled. In at least one implementation, SH₀ mode may be generated by a suitable ultrasonic wave transducer coupled to temperature sensor strip 108. In at least one implementation, transducer may excite ultrasonic horizontal shear waves that oscillate along a plane parallel to width dimension of waveguide, propagating down waveguide as SH₀ mode.

In at least one implementation, for selection of single mode propagation favoring SH₀ mode, temperature sensor strip 108 may conform to design criteria favoring SH₀ propagation in a strip waveguide. In at least one implementation, for substantially exclusive SH₀ mode excitation, a waveguide design rule may require that width of temperature sensor strip 108 be a minimum of 5 λ (e.g., w>5 λ), where λ is wavelength of frequency of excitation within material of waveguide. In at least one implementation, since λ=c/f, parameter c is velocity of propagation of SH₀ mode waves within material. In at least one implementation, velocity c may have a threshold value to meet design criterion of 5 λ<h for a desired operational frequency f. In at least one implementation, material selected may exhibit a shear velocity approximating c.

In at least one implementation, width of temperature sensor strip 108 is selected so that it does not exceed height h of sensor compartment 106. In at least one implementation, minimum width of temperature sensor strip 108 may be 52. In at least one implementation, for a design criterion using a maximum width of 10 mm, shear wavelength λ of ultrasonic waves may be 2 mm or less in an aluminum waveguide. In at least one implementation, for an operational frequency of approximately 1.5 MHz, a material exhibiting a shear velocity of at least 3000 m/s may be chosen for temperature sensor strip 108 so that λ may be approximately 2 mm. In at least one implementation, materials exhibiting shear velocities close to 3000 m/s may include aluminum, steel, nickel, titanium, tungsten, molybdenum, and borosilicate glass.

In at least one implementation, frequencies of operation of temperature sensor strip 108 supporting SH₀ mode propagation may be determined at least in part from frequency-dimension product, a figure of merit derived from analysis of dispersion relations within strip waveguides. In at least one implementation, dimension may be thickness of temperature sensor strip 108, where freq.×thickness≥1.565 MHz-mm, for SH₀ mode. In at least one implementation, a design rule may also exist for thickness of temperature sensor strip 108 based on frequency-thickness product. In at least one implementation, if thickness may be 1 mm or less, operational frequency may be at least approximately 1.5 MHz. In at least one implementation, frequency of operation may be further restricted by susceptibility to mode conversion and energy leakage occurring at frequencies below approximately 1 MHz. In at least one implementation, mode propagation may be further restricted by a low frequency cutoff below which mode no longer can propagate within material. In at least one implementation, SH₀ mode may have a cutoff of approximately 500 kHz in aluminum or steel for a width of approximately 7 or 8 mm.

Referring again to FIG. 1A, while plurality of grooves 112 are shown to be substantially uniform, in at least one implementation, some individual grooves 112 may have substantially different dimensions from others. In at least one implementation, grooves 112 may be combined with other types of structural discontinuities, such as bulges, bends and interfaces with other materials, as noted above. In at least one implementation, other structural materials that can be integrated into temperature sensor strip 108 may have a shear modulus that is different than bulk shear modulus of waveguide. In at least one implementation, grooves 112 may partially reflect injected ultrasonic energy back to source as it passes down waveguide to end of waveguide. In at least one implementation, some minor loss may occur by friction and leakage of energy from sidewalls. In at least one implementation, partially attenuated acoustic energy may be totally reflected from end of waveguide back to source, which may be an ultrasonic transducer as described below. In at least one implementation, multiple attenuated reflections may appear at source as echoes.

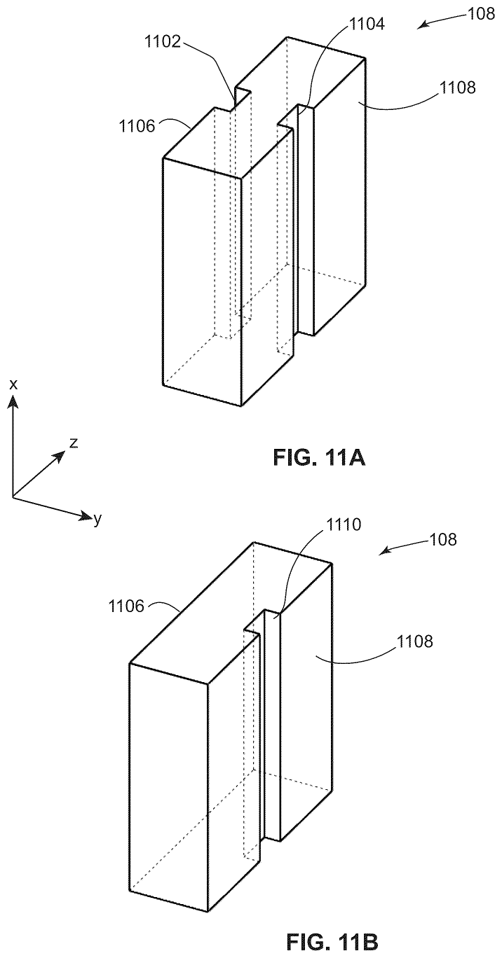

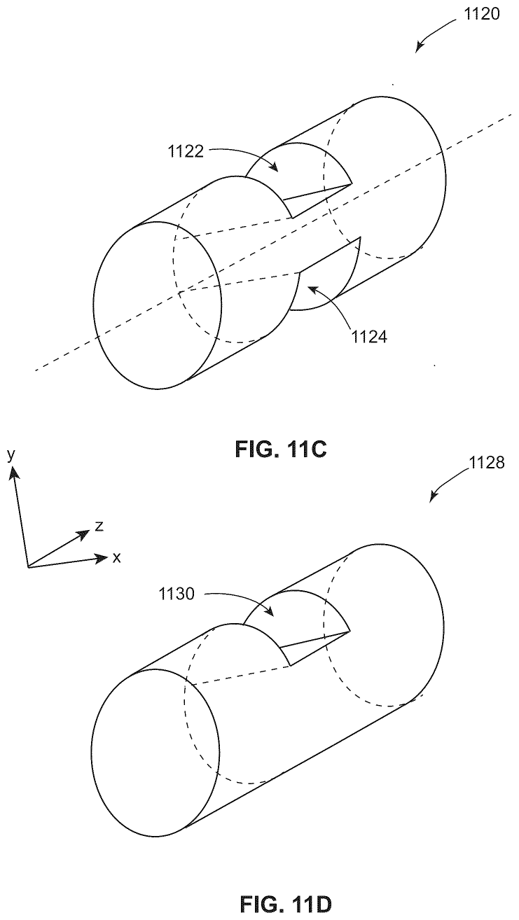

In at least one implementation, grooves 112 extend across full width w of temperature sensor strip 108, as shown. In at least one implementation, grooves 112 may extend partially across width w. In at least one implementation, grooves 112 have a rectangular cross section (example shown in FIG. 11A). In at least one implementation, grooves 112 may have rounded cross sections. In at least one implementation, grooves 112 may be symmetrically disposed on both sides of temperature sensor strip 108, as shown. In at least one implementation, grooves 112 may be asymmetrically disposed. In at least one implementation, grooves 112 may occur on one side, having no opposing groove.

In at least one implementation, pairs of adjacent grooves 112 may demark gauge lengths (e.g., lengthwise extents) of individual temperature sensors 110. In at least one implementation, gauge length of an individual temperature sensor 110 may coincide with a temperature zone within pedestal assembly 100 (or other process component). In at least one implementation, adjacent temperature sensors 110 may be within different temperature zones. In at least one implementation, heat transfer by any or all of conductive, convective, or radiative paths may permit individual temperature sensors 110 to thermally equilibrate with surroundings in immediate environment. In at least one implementation, approximately average zone temperature may be calculated as an average of temperatures from pairs of adjacent grooves 112. In at least one implementation, spatial resolution of temperature sensors 110 may be modified by adjustment of gauge lengths of some or all temperature sensors 110.

In at least one implementation, grooves 112 may be collocated at predetermined temperature measurement points distributed in a two-dimensional pattern on sensor support plate 102. In at least one implementation, temperature sensor strip 108 may be incorporated into sensor compartment 106 in several suitable geometries. In at least one implementation, temperature sensor strip 108 may be coiled into a spiral having a diameter suitable to fit within sensor compartment 106. Other suitably shaped implementations are described below. In at least one implementation, coordinates of positions may be pre-determined x-y or radial coordinates of sensor compartment 106. In at least one implementation, gauge length of individual temperature sensors 110 may also be adjusted as desired to increase or decrease spatial resolution of temperature measurements.

In at least one implementation, temperature sensor strip 108 may be coiled to fit within sensor compartment 106. In at least one implementation, a particular coil spiral may collocate grooves 112 at predetermined temperature probe positions along floor 114 of sensor compartment 106, as shown. In at least one implementation, spiral geometry of temperature sensor strip 108 may comprise a number of windings and winding pitch to co-locate temperature sensors 110 at specific positions within sensor compartment 106 to obtain temperature measurements. In at least one implementation, a two-dimensional mapping of temperature distribution on sensor support plate 102 and within pedestal assembly 100 may be determined by collection of TOF data of reflected ultrasonic pulses. In at least one implementation, temperature mapping data may be probed and updated continuously by launching pulses of ultrasonic energy into temperature sensor strip 108.

In at least one implementation, temperature sensor strip 108 may provide multipoint measurements with a single device (e.g., a metallic waveguide strip or wire), obviating multiple installations of discrete sensors to map temperatures in two- or three-dimensional space. In at least one implementation, demands of such installations can include complex cabling and electronic interfaces. In at least one implementation, thermocouples and RTDs may not be exposed to RF environments (nor ensuing plasmas) without special shielding. In at least one implementation, temperature sensor strip 108 is robust to RF and plasma environments. In at least one implementation, temperature sensor strip 108 can entail facile installation, utilizing relatively simple cabling and electronic interfacing. In at least one implementation, multipoint temperature measurements may be included in feedback circuitry to dynamically control heat output of heating elements to maintain spatial uniformity of temperature of a substrate during a deposition or etch process, for example.

In at least one implementation, temperature sensor strip 108 may comprise tail lead 116. In at least one implementation, tail lead 116 may have no reflective structures such as notches or grooves. In at least one implementation, tail lead 116 may extend orthogonally to sensor support plate 102. In at least one implementation, tail lead 116 may be angled by bending temperature sensor strip 108 in a desired direction. In at least one implementation, tail lead 116 may be routed though opening 118 in floor 114 of sensor support plate 102. In at least one implementation, tail lead 116 may be coupled to an ultrasonic transceiver (not shown) further below pedestal assembly 100.

In at least one implementation, heater support plate 104 comprises heater element 120 disposed on top surface 113 of heater support plate 104. In at least one implementation, heater element is operable to supply heat to pedestal assembly 100. In at least one implementation, heater element 120 may be a resistive element that may be coupled to an electrical power source. In at least one implementation, heater element 120 may be between heater support plate 104 and sensor support plate 102. In at least one implementation, a groove following outline of heater element 120 (shown as dashed hidden line) may be on bottom surface 121 of sensor support plate 102 to seat an upper portion of heater element 120 against sensor support plate 102. In at least one implementation, such a groove may increase thermal contact between heater element 120 and sensor support plate 102. In at least one implementation, heater element 120 may provide a source of heat to platen 128, to raise temperature of a wafer substrate to permit surface reactions to occur at desirable rates during a deposition or an etch process. In at least one implementation, temperature gradients, as well as hot or cold spots, may exist across platen and wafer substrate, which may affect quality and uniformity of deposition or etch.

In at least one implementation, power and electrical connections for electrical heating elements and electrodes may be supplied by cables and wires that may be routed within through pedestal stem 122. In at least one implementation, pedestal stem 122 extends from base 124 of heater support plate 104. In at least one implementation, pedestal stem 122 is a tubular structure through which tail lead 116 and heater element leads 126 may be routed. In at least one implementation pedestal stem 122 may comprise a flange (not shown) to attach to a support column.

FIG. 1B illustrates an assembled isometric view of pedestal assembly 100, in accordance with at least one implementation. In at least one implementation, pedestal assembly 100 further comprises platen 128. In at least one implementation, platen 128 is operable to support a semiconductor wafer. In at least one implementation, platen 128 comprises a metal such as aluminum, or a dielectric material, such as aluminum nitride. In at least one implementation, platen 128 comprises plasma electrodes (not shown) embedded within platen 128 below top surface 130. In at least one implementation, platen 128 comprises electrostatic clamp electrodes (not shown) for securing a wafer to top surface 130.

In at least one implementation, platen 128 may seat on rim 132 of sensor support plate 102. In at least one implementation, width w of temperature sensor strip 108 may be approximately equal to height h between floor 114 and rim 132 of sidewall 134 of sensor compartment 106. In at least one implementation, upper edge 136 of temperature sensor strip 108 is in thermal contact with platen 128. In at least one implementation, electrodes may be included within platen 128 for electrostatic clamping of a wafer substrate and/or for generating a RF plasma.

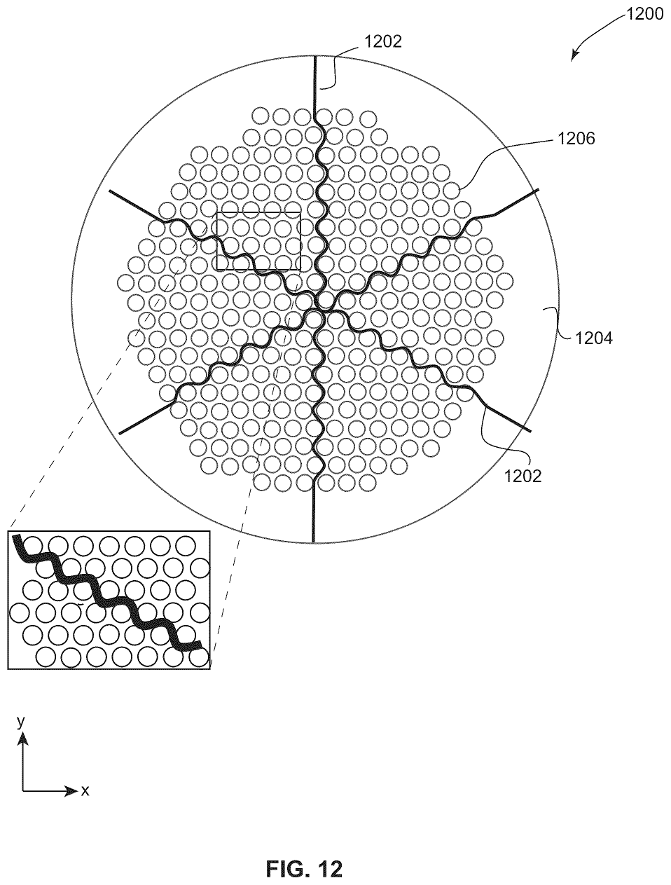

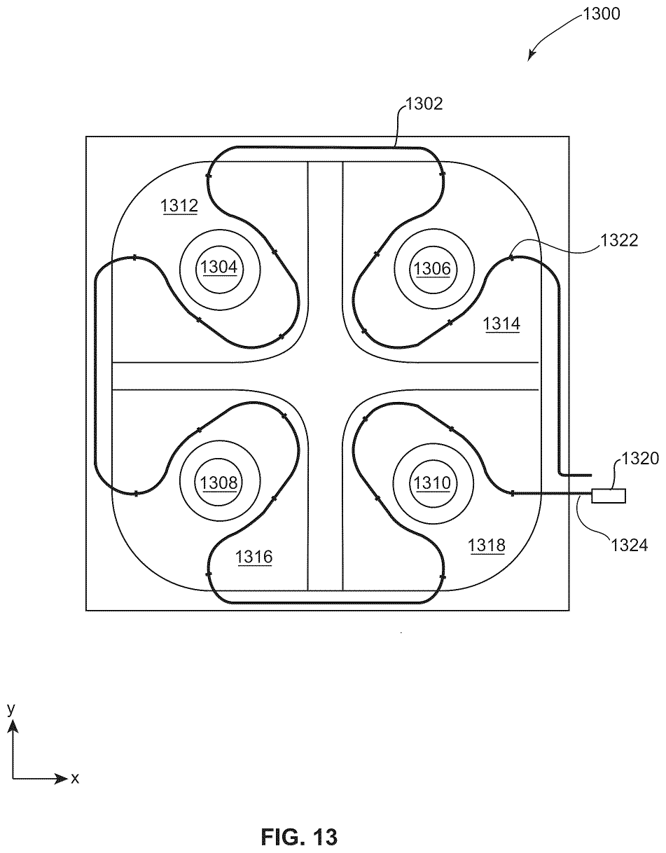

In at least one implementation, pedestal stem 122 may also provide a conduit for routing power conductors for electrostatic clamping (ESC) electrodes and radio frequency (RF) conductors for supplying ESC and plasma electrodes, respectively, within platen 128. Referring again to FIGS. 1A and 1B, while description of implementation of temperature sensor strip 108 may be in context of pedestal assembly 100, similar features may be common to other possible implementations, such as a process gas delivery showerhead (e.g., showerhead 1200, FIG. 12), or chamber surface (e.g., process tool 1300, FIG. 13).

FIG. 1C illustrates a plan view of pedestal assembly 100, in accordance with at least one implementation. In at least one implementation, inset shows an enlargement of grooves 112, showing a rectangular cross-sectional shape for grooves 112a and 112b. In at least one implementation, grooves 112a and 112b occur on opposite sidewalls 138 and 140 of temperature sensor strip 108. In at least one implementation, grooves 112 may be arranged non-symmetrically, as described below (e.g., see FIG. 11B).

In at least one implementation, grooves 112a and 112b may have a rounded cross section. In at least one implementation, certain design rules may be applied to width dimension L of grooves 112a and 112b. In at least one implementation, L may be determined by taking quotient of wavelength λ of SH₀ waves divided by 6 (e.g., λ/6). In at least one implementation, grooves 112 can have a width L that is substantially equal to or greater than ⅙ of wavelength of an acoustic signal to be propagated within waveguide. In at least one implementation, depth of grooves 112 may be approximately 100 to 300 microns. In at least one implementation, thickness t of temperature sensor strip 108 may be 1 mm or less.

In at least one implementation, temperature sensor strip 108 may be mechanically coupled to floor 114 by bonding temperature sensor strip 108 and/or to an opposing top plate (e.g., platen 128, FIG. 1B). In at least one implementation, sensor support plate 102 may be heated by convective, conductive, and/or radiative heat transfer from heater element 120. In at least one implementation, temperature gradients may develop within sensor compartment 106 and along surfaces of sensor support plate 102 and platen 128.

In at least one implementation, temperature sensor strip 108 may be optimally shaped to place temperature sensors 110 at predetermined locations in a central portion and periphery of sensor compartment 106. In at least one implementation, intermediate regions may not be in direct contact with temperature sensor strip 108. In at least one implementation, lateral temperature gradients may be interpolated by measuring temperatures at center and periphery, for example.

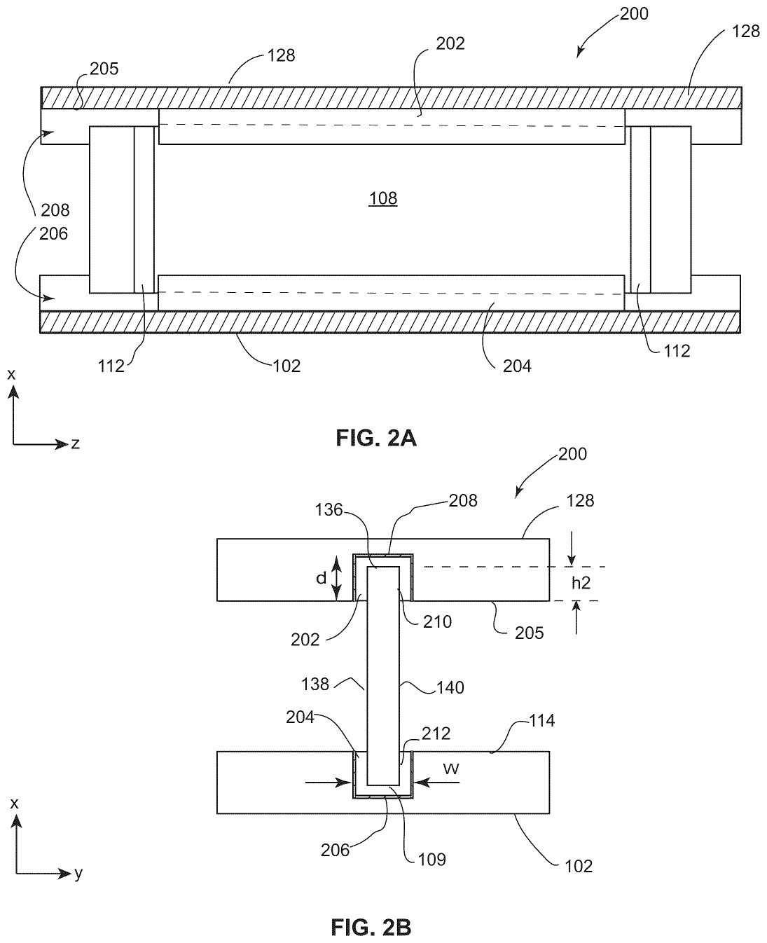

FIG. 2A illustrates a cross sectional view of temperature sensor strip assembly 200 anchored to sensor support plate 102 and platen 128, in accordance with at least one implementation. In at least one implementation, temperature strip assembly 200 comprises upper frame segment 202 and lower frame segment 204. In at least one implementation, lower edge 109 and upper edge 136 of temperature sensor strip 108 may seat within grooves (indicated by dashed lines) in lower support frame segment 204 and upper support frame segment 202.

In at least one implementation, floor 114 of sensor support plate 102 and surface 205 of platen 128 comprise grooves 206 and 208, respectively. In at least one implementation, upper frame segment 202 is seated within groove 208. In at least one implementation, lower frame segment 204 is seated within groove 206. In at least one implementation, lower frame segment 204 and upper frame segment 202 may augment structural rigidity of temperature sensor strip 108 and may be press-fitted or brazed to sidewalls of grooves 206 and 208, respectively. In at least one implementation, upper frame segment 202 and lower frame segment 204 may have any suitable length. In at least one implementation, upper and lower frame segments 202 and 204 may extend lengthwise between grooves 112 of temperature sensor strip 108. In at least one implementation, upper and lower frame segments 202 and 204 extend over grooves 112. In at least one implementation upper and lower frame segments 202 and 204 may be bonded on flat surfaces on floor 114 of sensor support plate 102 and surface 205 of platen 128, respectively.

FIG. 2B illustrates a cross-sectional view of temperature sensor strip assembly 200, in accordance with at least one implementation. In at least one implementation, FIG. 2B shows an orthogonal view (with respect to FIG. 2A) of anchoring temperature sensor strip 108 within pedestal assembly 100. In at least one implementation, upper edge 136 and lower edge 109 of temperature sensor strip 108 may be press-fit into grooves within upper and lower frame segments 202 and 204, respectively, without permanent bonding. In at least one implementation, temperature sensor strip 108 may be bonded to sidewalls of grooves 210 and 212 of upper and lower frame segments 202 and 204, respectively, by brazing or by an adhesive coating.

In at least one implementation, adjacent temperature sensors (e.g., temperature sensors 110, FIG. 1A) may be supported by upper and lower frame segments 202 and 204. In at least one implementation, upper and lower frame segments 202 and 204 may be mechanically coupled to every third, fourth or fifth temperature sensor (110). In at least one implementation, coverage of sidewalls 138 and 140 by upper and lower frame segments 202 and 204 may be limited to reduce leakage of ultrasonic energy from temperature sensor strip 108. In at least one implementation, height h₃ of lower frame segment 204 or upper frame segment 202 may be limited to cover only 10% to 20% of surface of sidewalls 138 and 140 to avoid measurable loss of energy and possible mode conversion.

In at least one implementation, grooves 206 and 208 are shown in cross section to illustrate width w and depth d. In at least one implementation, width w may be between 2 to 4 mm, depth d may be between 1 mm and 5 mm. In at least one implementation, grooves 206 and 208 may be machined into sensor support plate 102 and platen 128 to desired shape and dimensions during manufacture. In at least one implementation, grooves 206 and 208 may provide guided attachment of temperature sensor strip 108.

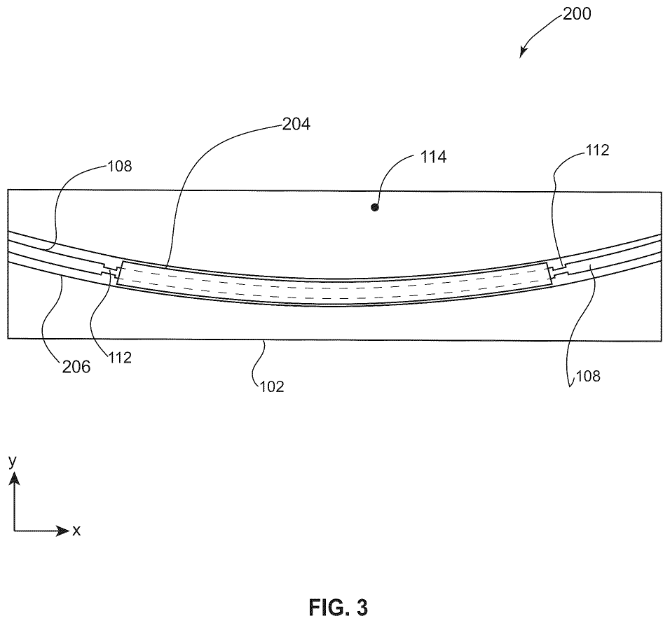

FIG. 3 illustrates a plan view of temperature sensor strip assembly 200, in accordance with at least one implementation. In at least one implementation, lower frame segment 204 can be bowed to follow curvature of groove 206 in sensor support plate 102, as illustrated. In at least one implementation, groove 206 may be in form of a spiral groove within sensor support plate 102, facilitating assembly of temperature sensor strip 108 into pedestal assembly 100. In at least one implementation, while curvature of lower frame segment 204 as depicted in FIG. 3 may substantially match corresponding spiral curvature of groove, lower frame segment 204 may have any suitable curvature or linearity to match a particular geometry of temperature sensor strip 108. In at least one implementation, shape of groove 206 may guide attachment of a temperature sensor strip 108 to sensor support plate 102 in any suitable geometry. In at least one implementation, upper frame segment 202, attached on upper edge 136 of temperature sensor strip 108, may be similarly curved to follow spiral curvature of a similar groove (208) in platen 128.

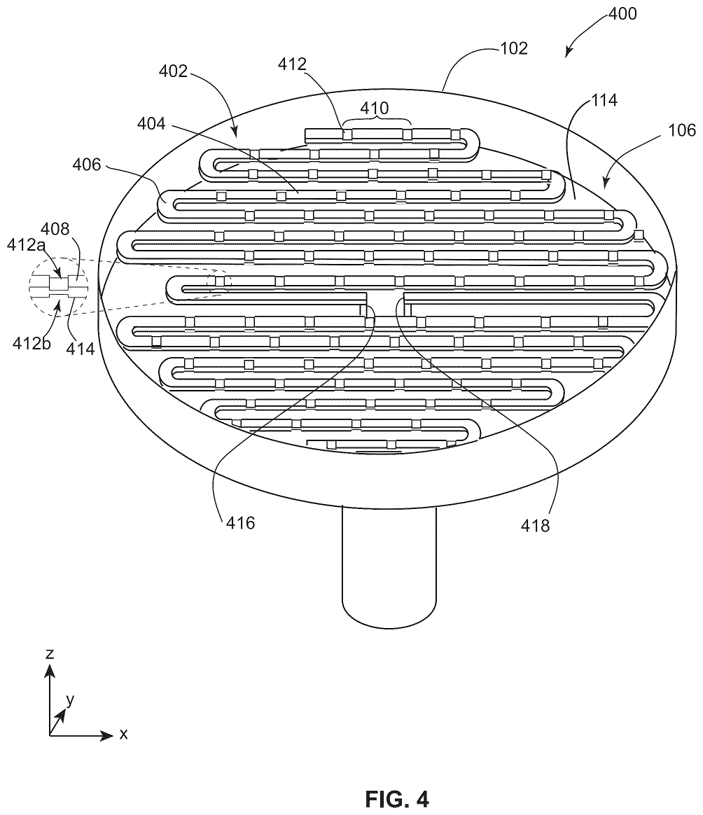

FIG. 4 illustrates an isometric 3-D view of pedestal assembly 400 comprising temperature sensor strip 402 supported on sensor support plate 102, in accordance with at least one implementation. In at least one implementation, temperature sensor strip 402 comprises a plurality of straight segments 404 joined by folded segments 406, forming a meandering serpentine geometry. In at least one implementation, temperature sensor strip 402 is shaped to fit within sensor compartment 106. In at least one implementation, straight segments 404 and folded segments 406 are oriented such that width w is parallel (flat) with respect to plane of floor 114 of sensor support plate 102. In at least one implementation, a serpentine shape may enable multiple temperature sensors 410 (e.g., segments of temperature sensor strip 402 between grooves 412) to be collocated in a rectangular grid pattern.

In at least one implementation, grooves 412 may be symmetric across upper sidewall 408 and lower sidewall 414 of temperature sensor strip 402, as shown in inset, comprising groove 412a on upper sidewall 408 and opposing groove 412b on lower sidewall 414. In at least one implementation, some or all of grooves 412 may be non-symmetrically distributed. In at least one implementation, one of upper or lower sidewalls 408 or 414 may comprise a groove (e.g., one of grooves 412a or 412b).

In at least one implementation, temperature sensor strip 402 may be coupled to an ultrasonic transducer (not shown) coupled to one or both of terminals 416 or 418. In at least one implementation, terminals 416 and 418 extend below sensor support plate 102 as described above (sec FIGS. 1A and 1B). In at least one implementation, one of terminals 416 or 418 may be a free terminal, enabling terminal reflections of ultrasonic energy excited by a transducer.

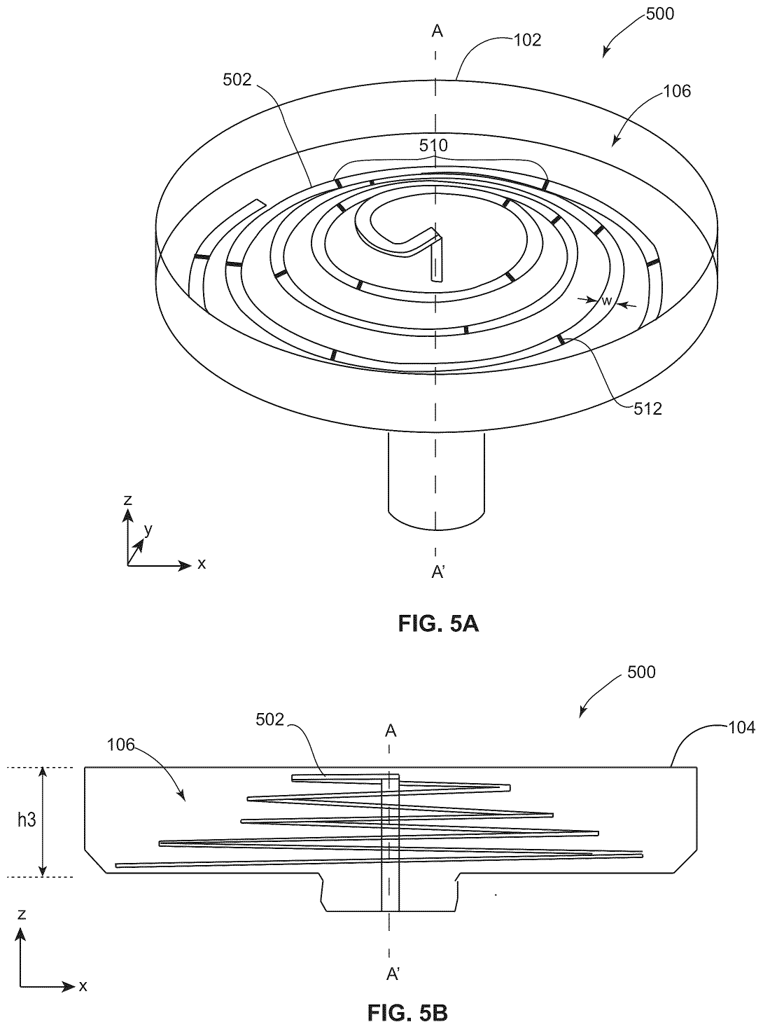

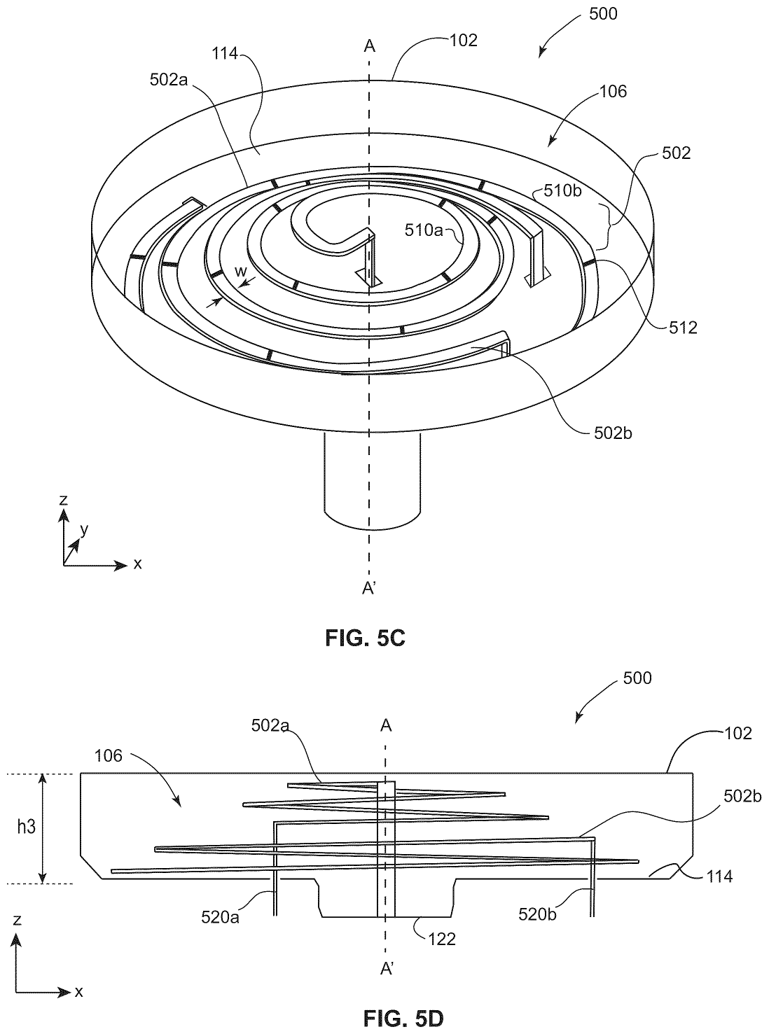

FIG. 5A illustrates an isometric 3-D view of pedestal assembly 500, in accordance with at least one implementation. In at least one implementation, temperature sensor strip 502 may be contained within sensor compartment 106 of sensor support plate 102. In at least one implementation, temperature sensor strip 502 is formed as a helical spiral. In at least tone implementation, temperature sensor strip 502 is oriented such that width w is aligned in x-y plane of figure (e.g., flat with respect to plane of floor 114). In at least one implementation, temperature sensor strip 502 may have a three-dimensional structure, whereby temperature sensor strip 502 occupies multiple planes within sensor compartment 106. In at least one implementation, a helical structure can enable mapping of temperatures in three-dimensional space within sensor compartment 106. In at least one implementation, multiple temperature sensors 510 may be collocated at desired three-dimensional coordinates within sensor compartment 106. In at least one implementation, adjustment of gauge lengths of temperature sensors 510, as well as radius and pitch of spirals along helical axis A-A′, can enable flexible collocation of temperature sensors 510. In at least one implementation, temperature sensors 510 extend between adjacent grooves 512.

FIG. 5B illustrates an orthogonal cross-sectional view of pedestal assembly 500, in accordance with at least one implementation. In at least one implementation, helical structure of temperature sensor strip spans approximately height h₃ of sensor compartment 106. As noted above, temperature sensor strip 502 may enable sensing of temperatures in three dimensions. In at least one implementation, temperature sensor strip 502 has a decreasing diameter along central axis A-A, enabling temperature measurements at multiple x,y coordinates within sensor compartment 106.

FIG. 5C illustrates an isometric 3-D view of pedestal assembly 500, in accordance with at least one implementation. In at least one implementation, temperature sensor strip 502 comprises two separate sections, temperature sensor strip 502a and temperature sensor strip 502b. In at least one implementation, both temperature sensor strip 502a and temperature sensor strip 502b may have a helical spiral form, as shown. In at least one implementation, temperatures sensor strip 502a is coaxial with temperature sensor strip 502b. In at least one implementation, separation of temperature sensor strip 502 into two or more sections can enable a higher quality of reflected signals returning to a transducer. In at least one implementation, attenuation of reflected signals may be a function of length of temperature sensor strip 502. In at least one implementation, dividing temperature sensor strip 502 into two or more units shortens overall signal path length in any one of sensors strips. In at least one implementation, signal to noise ratio may be improved, for example.

In at least one implementation, temperature sensor strips 502a and 502b may share a common helical axis A-A′. In at least one implementation, helical axis may further coincide with a central axis of sensor support plate 102. In at least one implementation, temperature sensor strip 502a may have a smaller lateral span than temperature sensor strip 502b. In at least one implementation, temperature sensors 510a and temperature sensors 510b may have same gauge length.

FIG. 5D illustrates an orthogonal cross-sectional view of pedestal assembly 500, according to at least one implementation. In at least one implementation, temperature sensor strip 502a may be stacked above temperature sensor strip 502b in a coaxial configuration. In at least one implementation, temperature sensor strips 502a and 502b comprise terminal leads 520a and 520b, respectively. In at least one implementation, terminal leads 520a and 520b extend below sensor support plate 102 for attaching to a transducer, for example. In at least one implementation, terminal leads 520a and 520b may be routed through pedestal stem 122.

FIG. 6 illustrates a plan view of pedestal assembly 600, comprising temperature sensor strip 602, according to at least one implementation. In at least one implementation, pedestal assembly 600 comprises temperature sensor strip 602 within sensor compartment 106 of sensor support plate 102. In at least one implementation, temperature sensor strip 602 comprises multiple straight segments 604. In at least one implementation, straight segments 604 extend between folds 606. In at least one implementation folds 606 have a radius of curvature of at least 1 mm. In at least one implementation, folds 606 may be bent at an angle of at least 90 degrees. In at least one implementation, segments 604 have uniform width w₂. In at least one implementation, segments 604 are oriented flat such that width w₂ is aligned with x-y plane of figure. In at least one implementation, adjacent straight segments 604 may be oriented at acute or obtuse angles with respect to one another. In at least one implementation, temperature sensor strip 602 is flat and substantially planar, having an overall height of 1 to 2 mm. In at least one implementation, several temperature sensor strips 602 may be deployed at multiple vertical levels within sensor compartment 106.

In at least one implementation, temperature sensor strip 602 comprises two sections, temperature sensor strip 602a and temperature sensor strip 602b. In at least one implementation, temperature sensor strips 602a and 602b may be juxtaposed within sensor compartment 106 such that terminal leads 608a and 608b are adjacent. In at least one implementation, terminal leads 608a and 608b may extend vertically (e.g., in z-direction) below sensor support plate 102 (for example, into pedestal stem 122, FIG. 1A and 1B) through opening 610. Temperature sensor strips 602a and 602b may be coupled to an ultrasonic transducer that is within

In at least one implementation, temperature sensors 612 extend between grooves 614. In at least one implementation, grooves 614 are principle reflector structures in temperature sensor strips 602a and 602b. In at least one implementation, folds 606 may not measurably reflect acoustic energy, and do not interfere with reflections from grooves 614.

In at least one implementation, while temperature sensor strip 602 may be configured by folding as shown in FIG. 6, other folding configurations are possible for optimal temperature sampling. In at least one implementation, temperature sensor strips 602a and 602b may be positioned by adjusting positions of temperature sensors 612 near measurement points, such as measurement points indicated by black dots in FIG. 6. In at least one implementation, measurement points may be predetermined. In at least one implementation, measure points may be near a heater element, such as heater element 120 (FIG. 1B), indicated by dashed outline below floor 114 of sensor support plate 102.

FIG. 7 illustrates a plan view of pedestal assembly 700, comprising temperature sensor strip 702, in accordance with at least one implementation. In at least one implementation, temperature sensor strip 702 comprises two separate temperature sensor strips 702a and 702b. In at least one implementation, temperature sensor strip 702 may be divided into two or more smaller temperature sensor strips to decrease acoustic signal path length for improving signal quality. In at least one implementation, temperature sensor strips 702a and 702b comprise terminal leads 704a and 704b, respectively, that may be routed through opening 706 in floor 114. In at least one implementation, terminal leads 704a and 704b may extend vertically (e.g., in z direction) below sensor support plate 102. In at least one implementation, terminal leads 704a and 704b may be attached to an ultrasonic transducer that sends pulses and receives reflected pulses (echoes) from temperature sensor strips 702a and 702b, respectively.

In at least one implementation, temperature sensor strips 702a and 702b comprise straight segments 708. In at least one implementation, straight segments 708 extend between folds 710. In at least one implementation, straight segments 708 may have any suitable length. In at least one implementation, straight segments 708 can have any suitable angle with respect to adjacent straight segments 708. In at least one implementation, straight segments 708 comprise at least one temperature sensor 712. In at least one implementation, temperature sensors 712 extend between grooves 714. In at least one implementation, grooves 714 are principle reflector structures in temperature sensor strips 702a and 702b. Folds 710 may have a bend radius adjusted to not cause measurable reflections. In at least one implementation, folds 710 may have a bend radius of 1 mm or greater.

In at least one implementation, temperature sensor strip 702a at least partially encircles temperature sensor strip 702b. In at least one implementation, temperature sensor strip 702a may be folded into a quasi-hexagonal configuration. In at least one implementation, temperature sensor strip 702a surrounds temperature sensor strip 702b. In at least one implementation, temperature sensor strip 702b may be folded into a compact shape that is confined to a center portion of sensor compartment 106. In at least one implementation, temperature sensor strip 702a extends through a peripheral region of sensor compartment 106. In at least one implementation, temperature sensors 712 may be collocated to sample temperatures near sampling points denoted by black dots in figure.

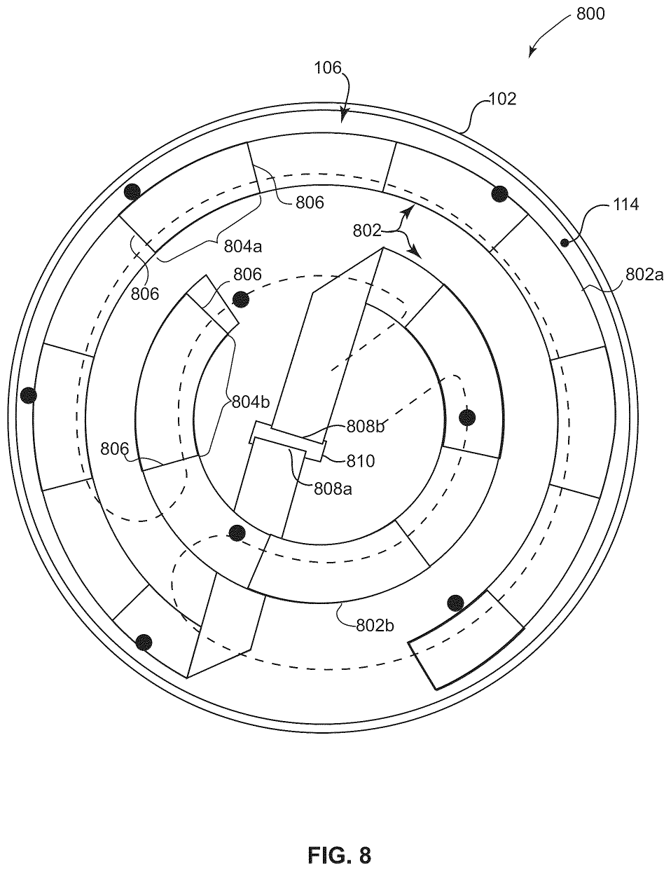

FIG. 8 illustrates a plan view of pedestal assembly 800 comprising temperature sensor strip 802, in according to at least one implementation. In at least one implementation, temperature sensor strip 802 comprises two smaller temperature sensor strip units, temperature sensor strip 802a and temperature sensor strip 802b. In at least one implementation, temperature sensor strips 802a and 802b are configured as circular arcs. In at least one implementation, temperature sensor strip 802a may follow an arc of sensor support plate 102 within a peripheral region of sensor compartment 106. In at least one implementation sensor support plate 102 may follow an inner arc of sensor support plate 102. In at least one implementation, arc configuration of both temperature sensor strips 802a and 802b distribute temperature sensors 804a and 804b near sample points, shown as black dots, in both peripheral and inner portions of sensor support plate 102.

In at least one implementation, temperature sensors 804a and temperature sensor 804b are distributed along temperature sensor strips 802a and 802b, respectively. In at least one implementation, temperature sensors 804a and 804b extend between grooves 806. In at least one implementation, temperature sensors 804a and 804b are curved segments of temperature sensor strips 802a and 802b, respectively. In at least one implementation, temperature sensors 804a and 804b can have similar or different lengths. In at least one implementation, length of temperature sensors 804a and 804b may be determined by sensor layout constraints that are related to number and positions of sampling points. Exemplary sampling points are indicated by black dots.

In at least one implementation, temperature sensor strips 802a and 802b comprise terminal leads 808a and 808b, respectively. In at least one implementation, terminal leads 808a and 808b may be routed through opening 810 in floor 114 of sensor support plate 102.

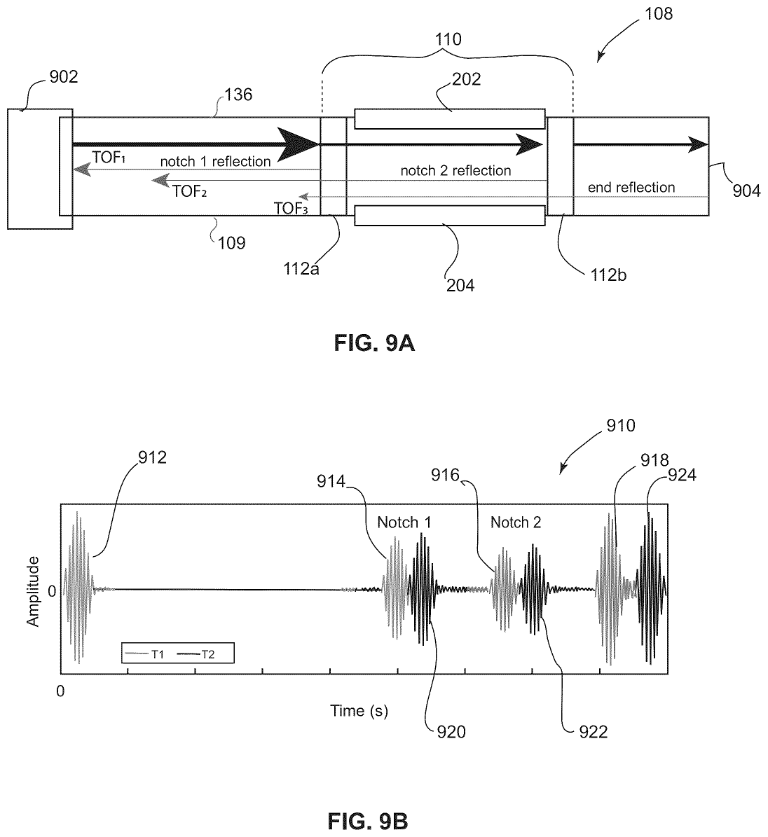

FIG. 9A illustrates a partial profile view of temperature sensor strip 108, in accordance with at least one implementation. In at least one implementation, temperature sensor strip 108 comprises temperature sensor 110 between grooves 112a and 112b. Upper edge 136 and lower edge 109 and of temperature sensor 110 are attached to lower and upper frame segments 202 and 204, respectively. Reference to type of discontinuity embodied by grooves 112a and 112b is indicated by labels notch 1 and notch 2. In at least one implementation, upper and lower frame segments 202 and 204, respectively, may extend between grooves 112a and 112b, as shown, but may be omitted. Here, arrows show directions of forward and reflected ultrasonic signals that are excited and received by transducer 902. In at least one implementation, transducer 902 may be coupled to terminal lead of temperature sensor strip 108, as shown. In at least one implementation, transducer 902 may be a piezoelectric transducer capable of producing mechanically excited shear waves (e.g., due to vibration normal to contact surface) of frequencies up to several megahertz. In at least one implementation, excitation of ultrasonic shear waves may be coupled to temperature sensor strip 108 by mechanical contact with transducer 902. In at least one implementation, transducer 902 may be mounted or attached to a sidewall of temperature sensor strip 108. Transducer 902 may be electrically coupled to a signal pulser/receiver unit (not shown).

In at least one implementation, reflected waves may be detected as an echo of transmitted pulse by same piezoelectric crystal that generates excitation, or by a separate piezoelectric crystal. In at least one implementation, grooves 112a and 112b may each reflect a portion of transmitted energy, for example 10% to 30%, depending on type and size of discontinuity. In at least one implementation, return signals comprising returning vibrations may excite voltages of same frequency in piezoelectric crystal, which are amplified by amplifier electronics in pulser/receiver unit. In at least one implementation, transducer 902 may be mounted on strip waveguide to excite shear waves normal to longitudinal axis of waveguide. In at least one implementation, if longitudinal excitation may be desired, transducer 902 may be rotated 90 degrees to excite waves along longitudinal axis of waveguide. In at least one implementation, a couplant comprising a highly viscid liquid is employed to increase coupling efficiency ultrasound into waveguide.

Here, large arrow emanating from transducer 902 may represent a forward burst of ultrasonic shear energy at time zero that travels down strip wave toward end 904 of temperature sensor strip 108. In at least one implementation, pulse may encounter groove 112a, which reflects some of energy back to transducer 902, as indicated by reverse arrow labeled “notch 1 reflection” of echo. In at least one implementation, time of travel of forward and reflected waves is time of flight (TOF). In at least one implementation, TOF labeled TOF₁, and may be measured in nanoseconds or microseconds, depending on distance between groove 112a and transducer 902 and shear velocity. Exemplary data are shown in TOF echogram of FIG. 9B.

In at least one implementation, un-reflected energy of forward travelling pulse continues past notch 1 (e.g., groove 112a) to propagate along gauge length of temperature sensor strip 108, where it encounters notch 2 (e.g., groove 112b). At notch 2, a fraction of energy is reflected again, forming a second echo that travels back toward transducer 902. This is indicted by arrow labeled notch 2 reflection. For clarity, arrows indicating reflected waves have a dark grey shading, while those indicating forward waves are black. In at least one implementation, echo from notch 2 is associated with TOF₂, time of flight of second echo that may be recorded by receiver unit coupled to transducer 902.

In at least one implementation, second echo arrives at a later time (TOF₂) than first echo (associated with TOF₁). In at least one implementation, difference TOF₂−TOF₁ may be represented as δTOF. In at least one implementation, TOF data may exhibit a measurable dependence on local temperatures within vicinity of notches 1 and 2, (e.g., grooves 112a and 112b, respectively). In at least one implementation, local temperature may be measured by calculating difference TOF₂−TOF₁ at different temperatures.

In at least one implementation, sound propagation parameters of solid materials, such as Young's modulus and shear modulus, have temperature dependencies that modify velocity of sound within a solid material. In at least one implementation, this temperature dependence accounts for shifts in TOF. In at least one implementation, velocity of sound decreases as temperature increases, lengthening measured TOF values. In at least one implementation, temperature-induced differences in TOF are measured from each groove 112a and 112b. In at least one implementation, calculated temperature may be considered a composite (e.g., average) temperature across gauge length of temperature sensor strip 108. In at least one implementation, in large temperature gradients, reducing gauge length of temperature sensors 110 may enable greater measurement resolution local temperatures.

In at least one implementation, a fraction of transmitted pulse impinging on notch 2 may continue to end 904 of temperature sensor strip 108. In at least one implementation, signal may be almost entirely reflected back to transducer 902 as a third echo. In at least one implementation, a third TOF, TOF₃, may be recorded by receiver unit coupled to transducer 902. In at least one implementation, a small fraction of energy impinging on end 904 may be absorbed by waveguide material or leak to surroundings. In at least one implementation, TOF₃ may not be included in temperature determination.

FIG. 9B illustrates echogram 910, in accordance with at least one implementation. In at least one implementation, echogram 910 shows a time-of-flight (TOF) measurement at two distinct temperatures from temperature sensor strip 108 shown in FIG. 9A. In at least one implementation, pulse echoes from grooves 112a and 112b are designated notch 1 and notch 2, respectively. Here. pulse packets shaded in grey indicate TOF data measured at temperature T₁ (e.g., T₁=30° C.), whereas pulse packets having black shading indicate TOF data measured at temperature T₂>>T₁ (e.g., T₂=300° C.). Referring to echogram 910, signal packet 912 represents an ultrasonic pulse injected into temperature sensor strip 108 at time zero (t₀). Signal packet 914 is reflection signal from notch 1, whereas signal packet 916 is reflection signal from notch 2. TOF of signal packets 916 and 918, respectively, may be indicted by a time scale in microseconds. Here, TOF measurement may be made at T₁. In at least one implementation, signal packet 918 may represent reflection from end 904 of temperature sensor strip 108.

In at least one implementation, shift of TOF data with temperature (δTOF) is indicated by signal packets 920, 922 and 924, respectively, for notches 1 and 2 (e.g., grooves 112a and 112b), measured at T₂. In at least one implementation, a measured TOF shift (e.g., δTOF) may be approximately 10 microseconds increase in TOF between T₁ and T₂ (e.g., between 30° C. and 300° C.). In at least one implementation, computation of δTOF may include TOF shift at an elevated temperature T₂ (e.g., 300° C.) from a reference temperature T₁ (e.g., 30° C.). In at least one implementation, δTOF=(TOF₂−TOF₁)_{T2}−(TOF₂−TOF₁)_{T1}, where TOF₂ and TOF₁ refer to time of flight measurements from reflections from notch 2 and notch 1, respectively.

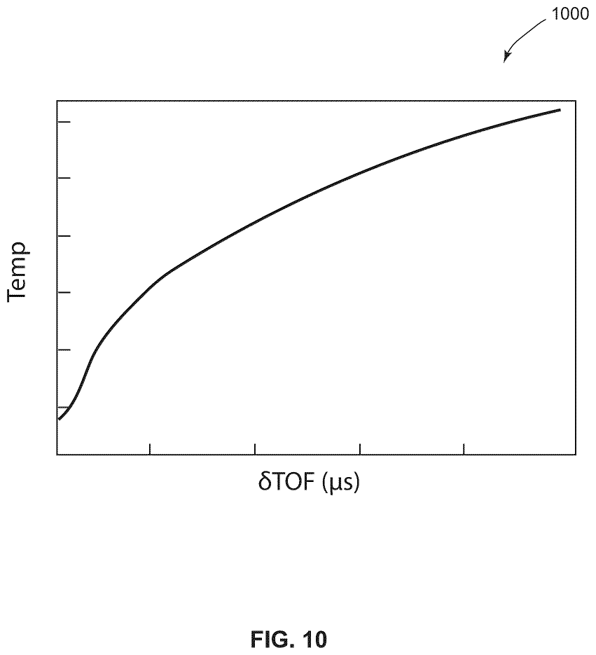

FIG. 10 illustrates an exemplary calibration curve 1000, in accordance with at least one implementation. In at least one implementation, calibration curve 1000 may be derived from δTOF measurements exemplified by echogram 910, relating temperature to measured δTOF. In at least one implementation, calibration curve 1000 may comprise measurements from temperature sensor strip 108 comprising symmetric grooves or non-symmetric groove discontinuities (e.g., see FIGS. 11A and 11B). In at least one implementation, data points from both variations (symmetric and non-symmetric) of discontinuities substantially coincide, as shown by two sets of data point in calibration curve 1000.

FIGS. 11A and 11B illustrate 3D views of symmetric grooves 1102, 1104 and a single non-symmetric groove 1110, respectively, in accordance with at least one implementation. In at least one implementation, FIG. 11A illustrates symmetric grooves 1102 and 1104 opposite one another on opposing sidewalls 1106 and 1108 of temperature sensor strip 108. In at least one implementation, FIG. 11B illustrates a non-symmetric groove 1110 on sidewall 1108 of temperature sensor strip 108.

FIG. 11C illustrates a three-dimensional view of cylindrical acoustic waveguide temperature sensor 1120 (shown as a segment), in accordance with at least one implementation. In at least one implementation, cylindrical acoustic waveguide temperature sensor comprises symmetric notches 1122 and 1124, respectively. In at least one implementation, symmetric notches 1122 and 1124 are opposed across a plane of symmetry along axis (indicated by dashed line) of cylindrical acoustic waveguide temperature sensor 1120. Symmetric notches 1122 and 1124 may form a reflector discontinuity, like grooves 112 (FIGS. 1A and 1B). FIG. 11D illustrates cylindrical acoustic waveguide 1128 in three-dimensional view, comprising a single non-symmetric notch 1130, in accordance with at least one implementation.

FIG. 12 illustrates a plan view of showerhead 1200, in accordance with at least one implementation. In at least one implementation, showerhead 1200 comprises one or more waveguide temperature sensors 1202. In at least one implementation, waveguide temperature sensor 1202 may be temperature sensor strip, such as temperature sensor strip 108. In at least one implementation, waveguide temperature sensor 1202 may be an optical sensor. In at least one implementation, showerhead 1200 may comprise multiple apertures 1206 in faceplate 1204. In at least one implementation, apertures 1206 may distribute deposition vapors and gases over a substrate that is mounted on one or more wafer pedestal assemblies. In at least one implementation, apertures 1206 may be arrayed in a hexagonal close packed configuration, as shown. In at least one implementation, apertures 1206 may be arrayed in other configurations, such as, but not limited to, square, rectangular, circular, or other suitable configurations.

In at least one implementation, faceplate temperatures may be controlled by heating wires attached to inside surface of faceplate 1204. In at least one implementation, heating wires may meander between apertures 1206. In at least one implementation, one or more waveguide temperature sensors 1202 may be attached to an inner surface of faceplate 1204 for monitoring temperatures of portions of showerhead 1200. In at least one implementation, waveguide temperature sensors 1202 may extend across one or more diameters of faceplate 1204 as shown. In at least one implementation, waveguide temperature sensors 1202 may comprise meanders between apertures 1206, as shown in inset. In at least one implementation, while two waveguide temperature sensors 1202 are shown, any suitable number of sensors may be included. In at least one implementation, angular and radial temperature gradients may be measured by including multiple waveguide temperature sensors 1202 at various angles on faceplate 1204.

FIG. 13 illustrates an implementation of a waveguide temperature sensor 1302 within process tool 1300, shown in plan view, in accordance with at least one implementation. In at least one implementation, process tool 1300 may be a single processing module comprising a single pedestal such as pedestal assembly 100, (e.g., FIGS. 1A and 1B). In at least one implementation, process tool 1300 comprises multiple processing stations arranged in a quad configuration. In at least one implementation, each processing station may comprise a single pedestal. In at least one implementation, pedestals 1304, 1306, 1308, or 1310 may be apportioned to one of four processing stations. In at least one implementation, one or more of pedestals 1304, 1306, 1308, or 1310 may receive wafer substrates introduced into process tool 1300 through a robot indexer arm (not shown) employed to transfer wafer substrates between pedestals 1304, 1306, 1308, or 1310.

In at least one implementation, multiple showerheads may be included at each processing station. In at least one implementation, one or more pedestals 1304, 1306, 1308 or 1310 may be paired with a showerhead, enabling separate process steps to be carried out at each process station. In at least one implementation, one or more pedestals 1304, 1306, 1308 or 1310 may be independently heated and/or cooled to execute process step to be carried out. In at least one implementation, precise control of pedestal temperature may be facilitated may inclusion of a waveguide temperature sensor 1302, within one or more pedestals. In at least one implementation, waveguide temperature sensor 1302 is a temperature sensor strip, such as temperature sensor strip 108. In at least one implementation, waveguide temperature sensor 1302 may be an optical temperature sensor. Reflector structures 1322 are shown as marks distributed along waveguide temperature sensor 1302. In at least one implementation, reflector structures 1322 may be grooves, such as grooves 112 (FIG. 1A).

In at least one implementation, process station surfaces 1312, 1314, 1316, and 1318 may be heated to prevent deposition of films on such surfaces by spray-over of process gas precursors. In at least one implementation, surface temperatures may be monitored by waveguide temperature sensor 1302. In at least one implementation, multiple waveguide temperature sensors 1302 may be routed over each of process station surfaces 1312-1318, as shown. In at least one implementation, waveguide temperature sensor 1302 may be coupled to transducer 1320 (e.g., an ultrasonic transducer or light source coupler) at one end (e.g., terminal lead 1324).

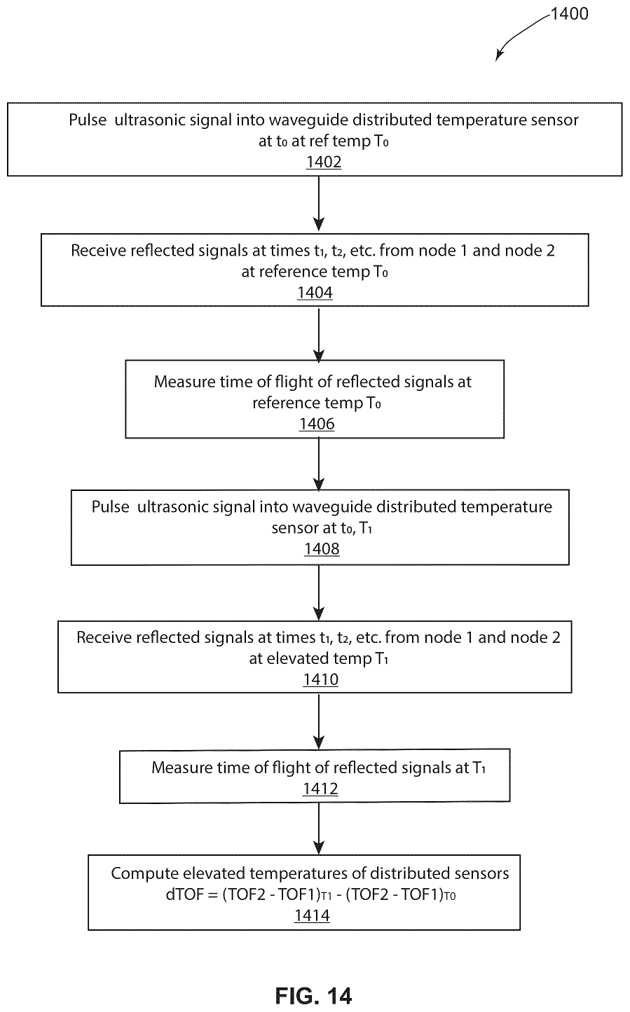

FIG. 14 illustrates process flow chart 1400 summarizing an exemplary method of operation of an ultrasonic waveguide temperature sensor coupled to a process tool, in accordance with at least one implementation. In at least one implementation, process flow chart 1400 comprises principal operations of method. Some principal operations may be preceded or followed by supporting operations that may be understood in art as routine or minor. In at least one implementation, these operations may be implied or omitted from following description of principal operations.

In at least one implementation, an example that follows may apply to a semiconductor process tool. (e.g., process tool 1300) as described above. In at least one implementation, process tool may include one or more process stations comprising a showerhead (e.g., showerhead 1200) and a pedestal (e.g., pedestals 1304-1310, FIG. 13). In at least one implementation, wafer substrates may be transferred between process stations by a robot indexer.

In at least one implementation, one or more acoustic waveguide temperature sensors (e.g., temperature sensor strip 108) may be incorporated into any or all process stations within process chamber. In at least one implementation, waveguide temperature sensors may also be included in showerheads (e.g., waveguide temperature sensors 1202), pedestals and chamber surfaces at a process station. While waveguide temperature sensors may be either acoustic or optical types, in at least one implementation any suitable combination of both types may be employed.

In at least one implementation, at operation 1402, acoustic signals are generated by an ultrasonic transducer and coupled into a waveguide temperature sensor (e.g., temperature sensor strip 108 or cylindrical acoustic waveguide temperature sensor 1120) at a process station. In at least one implementation, an ultrasonic transducer may be mechanically contacted to waveguide portion of temperature sensor strip at or on a terminal lead (e.g., transducer 902 in FIG. 9A). In at least one implementation, transducer may comprise a piezoelectric crystal electrically coupled to an electronic pulse generator and receiver. In at least one implementation, for strip waveguides, transducer may be oriented so that mechanical vibrations may be substantially orthogonal to axis of strip waveguide to inject shear waves into waveguide. In at least one implementation, acoustic pulses having frequencies of approximately 1 MHz or greater may be injected at preset intervals (e.g., at fractions of a second to minutes) into strip waveguide to favor horizontal shear mode (e.g., SH₀ mode). In at least one implementation, in cylindrical waveguides, similar frequencies may select transverse wave modes (e.g., T0 mode) that exhibit greatest temperature sensitivity for desired dimensions of waveguide.

In at least one implementation, injected acoustic pulses may travel down length of waveguide at velocity of sound of waveguide material. In at least one implementation, acoustic shear waves may travel at shear velocity of approximately 3000 m/s in aluminum or steel strip waveguides. In at least one implementation, acoustic waves may then reflect from discontinuities distributed along waveguide length. In at least one implementation, acoustic waves may reflect from groove discontinuities (e.g., grooves 112 formed on sidewalls of a waveguide temperature sensor). In at least one implementation, optical waveguides (e.g., fiber optic waveguides) may support Bragg reflections of white light that may be optically transferred to a spectrometer to measure wavelength displacement of individual spectral lines for temperature measurements.

In at least one implementation, signals may be injected into waveguide temperature sensor at some initial time to at a reference temperature T₀. In at least one implementation, T₀ may be room temperature (e.g., 20° C.-25° C.) or some other initial temperature of a process.

In at least one implementation, at operations 1404 and 1406, in at least one implementation, a reference temperature may be established for determination of elevated temperatures. In at least one implementation, a reference temperature may be measured at room temperature, according to at least one implementation. In at least one implementation, computation of elevated temperatures is referred to as a reference temperature. In at least one implementation, reflected acoustic wave signals may return to transducer as return signals and couple to a piezoelectric crystal, transforming acoustic return signals to electrical return signal analogs.

In at least one implementation, return signals may be measured and stored within electronic control unit associated with transducer. In at least one implementation, return signals reflected from reflector structures, such as grooves 112 in temperature sensor strip 108, may arrive at transducer at times t₁, t₂, etc., where t₂>t₁>t₀. Reflected signals may be detected and recorded at times t₁ and t₂. In at least one implementation, t₁ and t₂ may be tens to hundreds of microseconds, according to distances of each reflector (e.g., groove) from transducer. In at least one implementation, differences t1−t₀ and t₂−t₀ may be recorded as time-of-flight data TOF₁ and TOF₂, respectively, of acoustic energy reflected from consecutive discontinuities (e.g., notch 1 and notch 2). In at least one implementation, δTOF corresponding to a segment of waveguide temperature sensor between adjacent grooves (or other discontinuities) may be computed as δTOF=TOF₂−TOF₁. In at least one implementation, WDT sensor may comprise multiple adjacent DTS segments, each segment a temperature sensor. In at least one implementation, temperature of an individual temperature sensor on a waveguide temperature sensor may be determined by a measurement of δTOF at different temperatures and correlating data to temperature by a predetermined calibration curve (e.g., calibration curve 1000) relating δTOF data of a particular sensor to local temperature.

In at least one implementation, return signals from consecutive sensor segments (e.g., temperature sensors 110, FIGS. 1A and 1B) may be simultaneously measured and correlated to local temperature in environment of each consecutive sensor. In at least one implementation, local temperatures may be mapped accordingly as positions of individual sensor segments may be known within a one or more pedestal, showerhead or on a chamber surface.

In at least one implementation, at operations 1408, 1410 and 1412, measurements according to operations 1404 and 1406 may be repeated to measure elevated temperatures, for example, during a temperature ramp or cool down phase. In at least one implementation, temperatures may reach steady state at a target temperature. In at least one implementation, elevated temperatures may shift TOF data by reducing velocity of sound within a material, which may shift TOF to longer times. In at least one implementation, thermal expansion may cause an expansion of distance between reflectors, as well as changes in Young's and shear moduli, causing delays in TOF of acoustic signals. In at least one implementation, a ten-fold change in temperature from 30° C. to 300° C. may cause a delay of 10 microseconds in TOF, as noted above. In at least one implementation, in optical waveguide temperature sensors, elevated temperatures may cause changes in index of refraction. In at least one implementation, thermal expansion can cause increase in distance between grating discontinuities. In at least one implementation, such changes can cause shifts in angular or linear position of spectral lines. In at least one implementation, such temperature-induced spectral shifts may be correlated in a linear or quasi-linear manner to temperature within a range of interest, permitting calibration curves to be prepared.

In at least one implementation, at operation 1414, TOF data may be correlated to elevated temperatures by applying equation δTOF=(TOF₂−TOF₁)T₁−(TOF₂−TOF₁)T₂, where TOF₁ and TOF₂ refer to consecutive reflector discontinuities (e.g., grooves 112, FIGS. 1A and 1B).

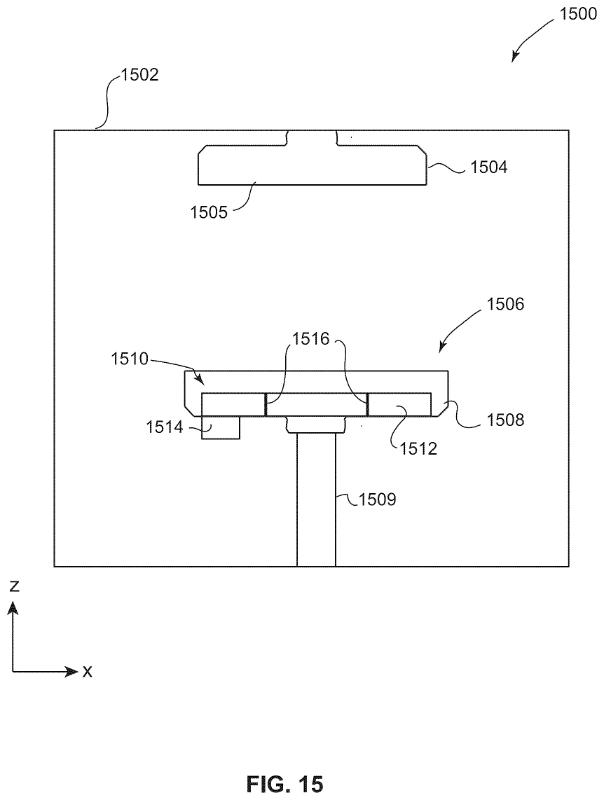

FIG. 15 illustrates system 1500 comprising a process tool, in accordance with at least one implementation. In at least one implementation, system 1500 may be a semiconductor process tool employed for CVD and/or PECVD. In at least one implementation, system 1500 comprises vacuum chamber 1502. In at least one implementation, vacuum chamber 1502 comprises showerhead 1504. In at least one implementation, showerhead 1504 comprises faceplate 1505 above and adjacent to pedestal 1506 (e.g., pedestal assembly 100, FIGS. 1A and 1B). In at least one implementation, showerhead 1504 may be substantially identical to showerhead 1200 described above. In at least one implementation, pedestal 1506 may comprise platen 1508 and stem 1509 coupled to platen 1508. In at least one implementation, pedestal 1506 comprises sensor compartment 1510. In at least one implementation, temperature sensor strip 1512 is within sensor compartment 1510. In at least one implementation, temperature sensor strip 1512 is substantially identical to temperature sensor strip 108 (FIG. 1A), described above. In at least one implementation, other waveguide temperature sensors than those described herein may be equally employed, such as cylindrical acoustic waveguide temperature sensor 1120.

In at least one implementation, transducer 1514 may be mechanically coupled to temperature sensor strip 1512. In at least one implementation, transducer 1514 is mounted on outside of pedestal 1506. In at least one implementation, transducer 1514 may be mounted within sensor compartment 1510. In at least one implementation, transducer 1514 may be physically contacted to a sidewall of temperature sensor strip 1512, for example, by a grease or paste layer to enhance acoustic coupling to temperature sensor strip 1512. In at least one implementation, orientation of vibration may determine dominant acoustic mode, for example, SH₀ or a longitudinal mode.

In at least one implementation, temperature sensor strip 1512 may comprise reflector structures 1516. In at least one implementation, reflector structures 1516 may be substantially identical to grooves 112 (FIGS. 1A and 1B). In at least one implementation, reflector structures 1516 may also be any suitable discontinuity, as described above.

In at least one implementation, transducer 1514 may inject acoustic waves into temperature sensor strip 1512 and receive return signals reflected from reflector structures 1516. In at least one implementation, transducer 1514 may comprise a piezoelectric crystal or polycrystalline vibrator than may generate mechanical vibrations and convert mechanical vibrations to voltage signals.

Examples are provided in following paragraphs that illustrate a least one implementation. Here, examples can be combined with other examples. As such, at least one implementation can be combined with at least another implementation without changing scope of at least one implementation.

Example 1 is a pedestal assembly, comprising a platen and a sensor support plate below the platen, wherein the sensor support plate comprises a sensor compartment; and a waveguide temperature sensor within the sensor compartment, wherein the waveguide temperature sensor comprises a temperature sensor, wherein the temperature sensor comprises a first reflector structure and a second reflector structure, and wherein the first reflector structure and the second reflector structure are separated by a gauge length.

Example 2 includes all features of example 1, wherein the waveguide temperature sensor comprises a strip having a rectangular cross section, wherein the rectangular cross section has a width and a length, and wherein the length is at least 10 times the width.

Example 3 includes all features of example 2, wherein the width is at least 5 times a wavelength of an acoustic signal to be propagated within the waveguide temperature sensor.

Example 4 includes all features of example 1, wherein the waveguide temperature sensor has a spiral geometry.

Example 5 includes all features of example 1, wherein the waveguide temperature sensor comprises a plurality of straight segments, wherein adjacent straight segments are coupled by folds.

Example 6 includes all features of example 1, wherein the waveguide temperature sensor comprises a circular arc.

Example 7 includes all features of example 1, wherein the waveguide temperature sensor comprises a first unit and a second units.

Example 8 includes all features of example 1, wherein the waveguide temperature sensor is bonded to a surface of the sensor compartment.

Example 9 includes all features of example 8, wherein the waveguide temperature sensor is within a groove in the surface of the sensor compartment.

Example 10 includes all features of example 9, wherein the waveguide temperature sensor comprises an upper edge coupled to an upper frame segment and a lower edge coupled to a lower frame segment, wherein the lower frame segment is mechanically coupled to the surface of the sensor compartment.

Example 11 includes all features of example 10, wherein the upper frame segment is coupled to the platen.

Example 12 includes all features of example 1, wherein the waveguide temperature sensor comprises a helical spiral.

Example 13 includes all features of example 1, wherein the waveguide temperature sensor comprises a first helical spiral portion and a second helical spiral portion above the first helical spiral portion, and wherein the second helical spiral portion is coaxial with the first helical spiral portion.

Example 14 includes all features of example 1, wherein the first reflector structure and the second reflector structure comprise a first groove and a second groove, respectively, on a sidewall of the waveguide temperature sensor, wherein the first groove and the second groove have a length that is at least a portion of a first width of the waveguide temperature sensor, and wherein the first groove and the second groove have a second width that is substantially equal to or greater than ⅙ of a wavelength of an acoustic signal to be propagated within the waveguide temperature sensor.

Example 15 includes all features of example 1, wherein the waveguide temperature sensor comprises a first material, wherein the first reflector structure and the second reflector structure comprise a second material, wherein the first material has a first shear modulus, the second material has a second shear modulus that is different from the first shear modulus.

Example 16 includes all features of example 15, wherein the first material comprises any one of aluminum, stainless steel, tungsten, titanium, silica, borosilicate glasses, aluminum oxide, titanium oxides, or aluminum nitride.

Example 17 includes all features of example 1, wherein the waveguide temperature sensor is substantially cylindrical.

Example 18 includes all features of example 1, wherein the waveguide temperature sensor is an optical fiber, and wherein the optical fiber comprises a plurality of fiber Bragg grating reflector structures or a coating comprising thermographic phosphors.

Example 19 is a system, comprising a vacuum chamber, a showerhead within the vacuum chamber; a pedestal within the vacuum chamber below the showerhead, the pedestal comprising a sensor compartment; and a waveguide temperature sensor within the sensor compartment, wherein the waveguide temperature sensor comprises at least one temperature sensor, wherein the at least one temperature sensor comprises a first reflector structure and a second reflector structure, and wherein the first reflector structure and the second reflector structure are separated by a gauge length wherein the at least one temperature sensor is collocated within the sensor compartment to coincide with one or more measurement locations; and a transducer coupled to a terminal lead of the waveguide temperature sensor.

Example 20 includes all features of example 19, wherein the transducer is operable to couple a signal into the waveguide temperature sensor and to receive one or more return signals, wherein the one or more return signals are reflected from the first reflector structure and the second reflector structure to the transducer.

Example 21 includes all features of example 19, wherein the waveguide temperature sensor is a first waveguide temperature sensor, and wherein the showerhead comprises a second waveguide temperature sensor adjacent to a faceplate of the showerhead.

Example 22 includes all features of example 21, wherein a third waveguide temperature sensor is thermally coupled to at least one surface of the vacuum chamber.

Example 23 is a method for measuring temperatures of a process, comprising coupling a signal pulse into a waveguide temperature sensor within a pedestal assembly, wherein the waveguide temperature sensor comprises a temperature sensor, wherein the temperature sensor comprises a first reflector structure and a second reflector structure, and wherein the first reflector structure and the second reflector structure are separated by a gauge length; receiving a first return signal and a second return signal reflected from the first and second reflector structures; measuring a first time-of-flight (TOF) of the first return signal and a second TOF of the second return signal; calculating a difference between the second TOF and the first TOF; and

correlating the difference with a temperature of one or more surfaces.

Example 24 includes all features of example 23, wherein measuring a first TOF of the first return signal and a second TOF of the second return signal comprises correlating the first return signal and the second return signal with the first reflector structure and the second reflector structure, and wherein the TOF of the first and second return signals is a function of a local pedestal temperature in a vicinity of the reflector structure.

Example 25 includes all features of example 23, further comprising increasing the temperature of the one or more surfaces of the pedestal assembly to a second temperature, wherein the temperature is a first temperature, and wherein the second temperature is greater than the first temperature.

Example 26 includes all features of example 25, wherein the difference is a first difference, and the method further comprises receiving a third return signal and a fourth return signal at the second temperature; measuring a third TOF of the third return signal and a fourth TOF of the fourth return signal, wherein the third TOF and the fourth TOF are measured at the second temperature; calculating a second difference between the fourth TOF and the third TOF; calculating a third difference between the first difference from the second difference; and correlating the third difference with the second temperature.

Besides what is described herein, various modifications may be made to at least one implementation without departing from their scope. Therefore, illustrations of at least one implementation herein should be construed as examples, and not restrictive to scope of at least one implementation.

1. A pedestal assembly, comprising:
a platen; and
a sensor support plate below the platen, wherein the sensor support plate comprises:
a sensor compartment; and
a waveguide temperature sensor within the sensor compartment, wherein the waveguide temperature sensor comprises a temperature sensor, wherein the temperature sensor comprises a first reflector structure and a second reflector structure, and wherein the first reflector structure and the second reflector structure are separated by a gauge length.

2. The pedestal assembly of claim 1, wherein the waveguide temperature sensor comprises a strip having a rectangular cross section, wherein the rectangular cross section has a width and a length, and wherein the length is at least 10 times the width.

3. The pedestal assembly of claim 2, wherein the width is at least 5 times a wavelength of an acoustic signal to be propagated within the waveguide temperature sensor.

4. The pedestal assembly of claim 1, wherein the waveguide temperature sensor has a spiral geometry.

5. The pedestal assembly of claim 1, wherein the waveguide temperature sensor comprises a plurality of straight segments, and wherein adjacent straight segments are coupled by folds.

6. The pedestal assembly of claim 1, wherein the waveguide temperature sensor comprises a circular arc.

7. The pedestal assembly of claim 1, wherein the waveguide temperature sensor comprises a first unit and a second unit.

8. The pedestal assembly of claim 1, wherein the waveguide temperature sensor is bonded to a surface of the sensor compartment.

9. The pedestal assembly of claim 8, wherein the waveguide temperature sensor is within a groove in the surface of the sensor compartment.

10. The pedestal assembly of claim 9, wherein the waveguide temperature sensor comprises an upper edge coupled to an upper frame segment and a lower edge coupled to a lower frame segment, wherein the lower frame segment is mechanically coupled to the surface of the sensor compartment.

11. The pedestal assembly of claim 10, wherein the upper frame segment is coupled to the platen.

12. The pedestal assembly of claim 1, wherein the waveguide temperature sensor comprises a helical spiral.

13. The pedestal assembly of claim 1, wherein the waveguide temperature sensor comprises a first helical spiral portion and a second helical spiral portion above the first helical spiral portion, and wherein the second helical spiral portion is coaxial with the first helical spiral portion.

14. The pedestal assembly of claim 1, wherein the first reflector structure and the second reflector structure comprise a first groove and a second groove, respectively, on a sidewall of the waveguide temperature sensor, wherein the first groove and the second groove have a length that is at least a portion of a first width of the waveguide temperature sensor, and wherein the first groove and the second groove have a second width that is substantially equal to or greater than 1/6 of a wavelength of an acoustic signal to be propagated within the waveguide temperature sensor.

15. The pedestal assembly of claim 1, wherein the waveguide temperature sensor comprises a first material, wherein the first reflector structure and the second reflector structure comprise a second material, wherein the first material has a first shear modulus, the second material has a second shear modulus that is different from the first shear modulus.

16. The pedestal assembly of claim 15, wherein the first material comprises any one of aluminum, stainless steel, tungsten, titanium, silica, borosilicate glasses, aluminum oxide, titanium oxides, or aluminum nitride.

17. The pedestal assembly of claim 1, wherein the waveguide temperature sensor is substantially cylindrical.

18. The pedestal assembly of claim 1, wherein the waveguide temperature sensor is an optical fiber, and wherein the optical fiber comprises a plurality of fiber Bragg grating reflector structures or a coating comprising thermographic phosphors.

19. A system, comprising:
a vacuum chamber;
a showerhead within the vacuum chamber;
a pedestal within the vacuum chamber below the showerhead, the pedestal comprising a sensor compartment;
a waveguide temperature sensor within the sensor compartment, wherein the waveguide temperature sensor comprises at least one temperature sensor, wherein the at least one temperature sensor comprises a first reflector structure and a second reflector structure, and wherein the first reflector structure and the second reflector structure are separated by a gauge length, wherein the at least one temperature sensor is collocated within the sensor compartment to coincide with one or more measurement locations; and
a transducer coupled to a terminal lead of the waveguide temperature sensor.

20. The system of claim 19, wherein the transducer is operable to couple a signal into the waveguide temperature sensor and to receive one or more return signals, and wherein the one or more return signals are reflected from the first reflector structure and the second reflector structure to the transducer.

21. The system of claim 19, wherein the waveguide temperature sensor is a first waveguide temperature sensor, and wherein the showerhead comprises a second waveguide temperature sensor adjacent to a faceplate of the showerhead.

22. The system of claim 21, wherein a third waveguide temperature sensor is coupled to at least one surface of the vacuum chamber.

23. A method for measuring temperatures of a process, comprising:
coupling a signal pulse into a waveguide temperature sensor within a pedestal assembly, wherein the waveguide temperature sensor comprises a temperature sensor, wherein the temperature sensor comprises a first reflector structure and a second reflector structure, and wherein the first reflector structure and the second reflector structure are separated by a gauge length;
receiving a first return signal and a second return signal reflected from the first reflector structure and the second reflector structure, respectively;
measuring a first time-of-flight (TOF) of the first return signal and a second TOF of the second return signal;
calculating a difference between the second TOF and the first TOF; and
correlating the difference with a temperature of one or more surfaces.

24. The method of claim 23, wherein measuring the first TOF of the first return signal and the second TOF of the second return signal comprises correlating the first return signal and the second return signal with the first reflector structure and the second reflector structure, respectively, and wherein the first TOF of the first return signal and the second TOF of the second return signal is a function of a local pedestal temperature in a vicinity of the first and second reflector structures.

25. The method of claim 23, further comprising increasing the temperature of the one or more surfaces of the pedestal assembly to a second temperature, wherein the temperature is a first temperature, and wherein the second temperature is greater than the first temperature, wherein the difference is a first difference, and the method further comprises:
receiving a third return signal and a fourth return signal at the second temperature;
measuring a third TOF of the third return signal and a fourth TOF of the fourth return signal, wherein the third TOF and the fourth TOF are measured at the second temperature:
calculating a second difference between the fourth TOF and the third TOF:
calculating a third difference between the first difference from the second difference; and
correlating the third difference with the second temperature.

26. (canceled)
